(19) United States
(12) Patent Application Publication
(10) Pub. No.: US 2008/0254743 A1
(43) Pub. Date: Oct. 16, 2008

(54) Wireless Communication System

(76) Inventors: Yoshikane Nishikawa, Hyogo (JP); Toshio Sakimura, Osaka (JP); Makoto Funabiki, Osaka (JP); Akihiro Tatsuta, Kyoto (JP)

Correspondence Address: WENDEROTH, LIND & PONACK L.L.P., 2033 K. STREET, NW, SUITE 800, WASHINGTON, DC, 20006, US

(21) Appl. No.: 12/088,819

(22) PCT Filed: Oct. 2, 2006
(86) PCT No.: PCT/JP2006/319712

§ 371 Date: Jun. 20, 2008

(30) Foreign Application Priority Data
Sep. 30, 2005 (JP) 2005-287113

(51) Int. Cl. H04B 7/15; H04B 7/24

(52) U.S. Cl. 455/24; 455/7

(57) ABSTRACT

In a wireless repeater apparatus communicating with wireless communication apparatuses, a switching circuit transfers a data packet received through any one of antennas to any one of antennas for transmission. A correspondence table memory stores a correspondence table that includes relations of an identifier of each antenna between an identifier of each wireless communication apparatus. A wireless repeater apparatus control circuit controls transfer of the data packet by the switching circuit based on the correspondence table.

### BACKGROUND OF THE INVENTION

1. Field of the Invention

The present invention relates to a wireless communication apparatus for transmitting and receiving communication signals such as data packets, and relates to a wireless repeater apparatus for relaying the communication signals, and relates to a wireless communication system including the wireless communication apparatus and the wireless repeater apparatus.

2. Description of the Related Art

Conventional wireless communication systems requiring to set communication directions include those which utilize an optical communication technique (e.g., see the Japanese Patent laid-open Publication H09-107330).

FIG. 1 shows an appearance of an optical wireless communication system according to a prior art described in the Japanese Patent laid-open Publication H09-107330. The optical communication system includes a master set apparatus (hereinafter referred to as a “master set”) 101 and a slave set apparatus (hereinafter referred to as a “slave set”) 104. The master set 101 is provided with a communication light emitting portion 102 for usual optical communication, a search light emitting portion 103 outputting a light of wide directivity for optical axis adjustment, and a light receiving portion 105. The slave set 104 is provided with a light receiving portion 105. For starting the optical axis adjustment of the slave set 104, the search light emitting portion 103 of the master set 101 is lit, and the optical axis is adjusted so that an amount of received light is maximized at the light receiving portion 105 of the slave set 104 by using a light of wide directivity. Subsequently, the optical axis is adjusted by using idle lights sent from the communication light emitting portions 102 of the master set 101 and the slave set 104.

FIG. 2 is a block diagram showing an exemplary operation of the prior art optical wireless communication system described in the Japanese Patent laid-open Publication H09-107330. In FIG. 2, when the master set 101 communicating with the slave set 104 wishes to interrupt communication with the slave set 104 and start communication with another slave set 201 configured in a manner similar to that of the slave set 104, the master set 101 can communicate with the slave set 201 by performing optical axis adjustment in a manner similar to that described with reference to FIG. 1.

### SUMMARY OF THE INVENTION

However, the above prior art configuration has such a problem that the master set 101 needs to readjust optical axis to the slave set 201 when the master set 101 changes its remote party of communication from the slave set 104 to the slave set 201.

An object of the present invention is to solve the aforementioned problem of prior art, and to provide a wireless communication system requiring to set communication directions, but without requiring to newly set a communication direction when a wireless communication apparatus changes its remote party of communication, and to provide a wireless communication apparatus and a wireless repeater apparatus that constitute the wireless communication system.

In order to solve the problem of the prior art, according to a first aspect of the present invention, a wireless repeater apparatus for communicating with at least two wireless communication apparatuses is provided, the wireless repeater apparatus comprising:

a plurality of antennas;

switching means for transferring a communication signal received through any one of the plurality of antennas to any one of the plurality of antennas for transmitting the same communication signal therefrom;

correspondence table storing means for storing a correspondence table that includes relations in which an identifier of each antenna is correspondingly associated with an identifier of one wireless communication apparatus communicatable by using the antenna specified by the identifier of the antenna, and

wireless repeater apparatus control means for controlling transfer of the communication signal by the switching means, based on the correspondence table,

wherein when the communication signal is received through any one of the plurality of antennas, the wireless repeater apparatus control means obtains from the correspondence table the identifier of the antenna corresponding to an identifier of a destination wireless communication apparatus of the received communication signal, and controls the switching means to transfer the received communication signal to the antenna specified by the obtained identifier of the antenna for transmitting the same communication signal therefrom.

The wireless repeater apparatus is characterized in that, wherein when relaying a communication between a first wireless communication apparatus and a second wireless communication apparatus, the wireless repeater apparatus

transmits a communication response signal to the first wireless communication apparatus on behalf of the second wireless communication apparatus upon receiving a communication signal transmitted from the first wireless communication apparatus and addressed to the second wireless communication apparatus, and

transmits a communication response signal to the second wireless communication apparatus on behalf of the first wireless communication apparatus upon receiving a communication signal transmitted from the second wireless communication apparatus and addressed to the first wireless communication apparatus.

The wireless repeater apparatus is characterized in that,

wherein when a communication signal from a certain wireless communication apparatus is received through any one of the plurality of antennas, the wireless repeater apparatus control means further updates the correspondence table so as to add a relation in which the identifier of the antenna that has received the communication signal is correspondingly associated with an identifier of a source wireless communication apparatus of the communication signal, and

wherein the wireless repeater apparatus control means further:

receives a communication signal addressed to a certain wireless communication apparatus through any one of the plurality of antennas,

transfers the received communication signal to an antenna specified by the identifier of the antenna corresponding to the identifier of the destination wireless communication apparatus of the received communication signal in the correspondence table, for transmitting the same communication signal therefrom, and

when a communication response signal for the transmitted communication signal has not been received from the destination wireless communication apparatus within a certain time period, deletes from the correspondence table the identifier of the wireless communication apparatus corresponding to the identifier of the antenna that has transmitted the communication signal.

Moreover, the wireless repeater apparatus is characterized in that, wherein the wireless repeater apparatus control means further:

selects an identifier of a certain wireless communication apparatus in the correspondence table,

obtains an identifier of an antenna corresponding to the identifier of the selected wireless communication apparatus from the correspondence table,

generates a monitoring signal,

transmits the generated monitoring signal from the antenna specified by the obtained identifier of the antenna, and

when a monitoring response signal for the transmitted monitoring signal has not been received from the wireless communication apparatus specified by the selected identifier of the wireless communication apparatus within a certain time period, deletes the selected identifier of the wireless communication apparatus from the correspondence table.

Further, the wireless repeater apparatus is characterized in that,

wherein the wireless repeater apparatus further comprises communication signal storing means for storing the received communication signal, and

wherein when a communication response signal for the transmitted communication signal has not been received from the destination wireless communication apparatus within a certain time period, the wireless repeater apparatus control means further controls the switching means to transfer the communication signal that has been received and stored in the communication signal storing means, to an antenna specified by the identifier of the antenna that does not have any identifier of the corresponding wireless communication apparatus in the correspondence table, for retransmitting the same communication signal therefrom.

According to a second aspect of the present invention, a wireless communication system is provided including a wireless repeater apparatus of the first aspect of the present invention and at least one wireless communication apparatus,

wherein the wireless repeater apparatus further comprises:

at least one first antenna set comprised of antennas sharing the same identifier of the antenna, among the plurality of antennas,

first antenna selecting means switchable to select one antenna of each of the first antenna set, and

feedback transmitting means for transmitting, when the first antenna selecting means is switched to select one antenna of each of the first antenna set, a feedback signal that contains reception state information of the communication signal transmitted from the wireless communication apparatus and received through the selected antenna, to the source wireless communication apparatus of the communication signal,

wherein the wireless repeater apparatus control circuit further controls the first antenna selecting means based on the reception state information of the communication signal, to receive the communication signal transmitted from the source wireless communication apparatus of the communication signal, and

wherein the at least one wireless communication apparatus comprises:

at least one second antenna set comprised of antennas,

second antenna selecting means switchable to select one antenna of each of the second antenna set,

feedback receiving means for receiving the feedback signal transmitted from the wireless repeater apparatus, and

wireless communication apparatus control means for controlling the second antenna selecting means, and

wherein when the second antenna selecting means is switched to select one antenna of each of the second antenna set, the wireless communication apparatus control means further transmits the communication signal to the wireless repeater apparatus through the selected antenna, and controls the second antenna selecting means based on the reception state information contained in the received feedback signal, so that the communication signal is received by the wireless repeater apparatus.

The wireless communication system is characterized in that,

wherein the reception state information includes at least one of a reception level of the communication signal, a reception result of the communication signal, information of an antenna switching state of the first antenna selecting means, and the communication signal received by the wireless repeater apparatus.

Moreover, the wireless communication system is characterized in that,

wherein the wireless repeater apparatus further comprises first antenna selection information storing means for storing antenna selection information indicating the antenna that has been selected by the first antenna selecting means when the communication signal is received from the wireless communication apparatus,

wherein when newly receiving a communication signal from the wireless communication apparatus, the wireless repeater apparatus control means reads the antenna selection information from the first antenna selection information storing means, and switches the first antenna selecting means based on the read antenna selection information, so as to select one antenna of each of the first antenna set,

wherein the wireless communication apparatus further comprises second antenna selection information storing means for storing antenna selection information indicating the antenna that has been selected by the second antenna selecting means when the communication signal is received by the wireless repeater apparatus, and

wherein when newly transmitting a communication signal to the wireless repeater apparatus, the wireless communication apparatus control means reads the antenna selection information from the second antenna selection information storing means, and switches the second antenna selecting means based on the read antenna selection information, so as to select one antenna of each of the second antenna set.

Further, the wireless communication system is characterized in that,

wherein each of the first antenna set comprises a plurality of first antenna pairs each including one transmitting antenna and one receiving antenna corresponding to each other,

wherein the first antenna selecting means selects, upon selecting one receiving antenna of each of the first antenna set, one transmitting antenna corresponding to the selected receiving antenna,

wherein each of the second antenna set comprises a plurality of second antenna pairs each including one transmitting antenna and one receiving antenna corresponding to each other, and

wherein the second antenna selecting means selects, upon selecting one transmitting antenna of each of the first antenna set, one receiving antenna corresponding to the selected transmitting antenna.

Furthermore, the wireless communication system is characterized in that,

wherein with respect to each of the first antenna pairs, a coverage area of the transmitting antenna and a coverage area of the receiving antenna mutually overlap, and coverage areas of the different transmitting antennas do not mutually overlap, and

wherein with respect to each of the second antenna pairs, a coverage area of the transmitting antenna and a coverage area of the receiving antenna mutually overlap, and coverage areas of the different transmitting antennas do not mutually overlap.

According to a third aspect of the present invention, a wireless communication system is provided including the wireless repeater apparatus of the first aspect of the present invention and at least one wireless communication apparatus,

wherein the wireless repeater apparatus further comprises:

at least one first antenna set comprised of antennas sharing the same identifier of the antenna, among the plurality of antennas,

first antenna selecting means switchable to select one antenna of each of the first antenna set, and

feedback receiving means for receiving, when the first antenna selecting means is switched to select one antenna of each of the first antenna set, a feedback signal that contains reception state information of the communication signal transmitted through the selected antenna and received by the wireless communication apparatus, from the wireless communication apparatus,

wherein when the first antenna selecting means is switched to select one antenna of each of the first antenna set, the wireless repeater apparatus control means further transmits the communication signal to the wireless communication apparatus through the selected antenna, and controls the first antenna selecting means based on the reception state information contained in the received feedback signal, so that the communication signal is received by the wireless communication apparatus,

wherein the at least one wireless communication apparatus comprises:

at least one second antenna set comprised of antennas,

second antenna selecting means switchable to select one antenna of each of the second antenna set, and

feedback transmitting means for transmitting, when the second antenna selecting means is switched to select one antenna of each of the second antenna set, a feedback signal that contains reception state information of the communication signal transmitted from the wireless repeater apparatus and received through the selected antenna, to the wireless repeater apparatus, and

wireless communication apparatus control means for controlling the second antenna selecting means, and

wherein the wireless communication apparatus control circuit further controls the second antenna selecting means based on the reception state information of the communication signal, to receive the communication signal transmitted from the wireless repeater apparatus.

The wireless communication system is characterized in that,

wherein the reception state information includes at least one of a reception level of the communication signal, a reception result of the communication signal, information of an antenna switching state of the second antenna selecting means, and the communication signal received by the wireless communication apparatus.

Moreover, the wireless communication system is characterized in that,

wherein the wireless repeater apparatus further comprises first antenna selection information storing means for storing antenna selection information indicating the antenna that has been selected by the first antenna selecting means when the communication signal is received by the wireless communication apparatus,

wherein when newly transmitting a communication signal to the wireless communication apparatus, the wireless repeater apparatus control means reads the antenna selection information from the first antenna selection information storing means, and switches the first antenna selecting means based on the read antenna selection information, so as to select one antenna of each of the first antenna set,

wherein the wireless communication apparatus further comprises second antenna selection information storing means for storing antenna selection information indicating the antenna that has been selected by the second antenna selecting means when the communication signal is received from the wireless repeater apparatus, and

wherein when newly receiving a communication signal from the wireless repeater apparatus, the wireless communication apparatus control means reads the antenna selection information from the second antenna selection information storing means, and switches the second antenna selecting means based on the read antenna selection information, so as to select one antenna of each of the second antenna set.

Further, the wireless communication system is characterized in that,

wherein each of the first antenna set comprises a plurality of first antenna pairs each including one transmitting antenna and one receiving antenna corresponding to each other,

wherein the first antenna selecting means selects, upon selecting one transmitting antenna of each of the first antenna set, one receiving antenna corresponding to the selected transmitting antenna,

wherein each of the second antenna set comprises a plurality of second antenna pairs each including one transmitting antenna and one receiving antenna corresponding to each other, and

wherein the second antenna selecting means selects, upon selecting one receiving antenna of each of the second antenna set, one transmitting antenna corresponding to the selected receiving antenna.

Furthermore, the wireless communication system is characterized in that,

wherein with respect to each of the first antenna pairs, a coverage area of the transmitting antenna and a coverage area of the receiving antenna mutually overlap, and coverage areas of the different transmitting antennas do not mutually overlap, and

wherein with respect to each of the second antenna pairs, a coverage area of the transmitting antenna and a coverage area of the receiving antenna mutually overlap, and coverage areas of the different transmitting antennas do not mutually overlap.

According to a fourth aspect of the present invention, the wireless repeater apparatus of the first aspect of the present invention is further characterized in that, wherein the wireless repeater apparatus further comprises:

at least one antenna set comprised of antennas sharing the same identifier of the antenna, among the plurality of antennas,

antenna selecting means switchable to select one antenna of each of the antenna set, and

feedback transmitting means for transmitting, when the antenna selecting means is switched to select one antenna of each of the antenna set, a feedback signal that contains reception state information of the communication signal transmitted from a wireless communication apparatus and received through the selected antenna, to the source wireless communication apparatus of the communication signal, and

wherein the wireless repeater apparatus control circuit further controls the antenna selecting means based on the reception state information of the communication signal, to receive the communication signal transmitted from the source wireless communication apparatus of the communication signal.

The wireless repeater apparatus is characterized in that,

wherein the reception state information includes at least one of a reception level of the communication signal, a reception result of the communication signal, information of an antenna switching state of the antenna selecting means, and the communication signal received by the wireless repeater apparatus.

Moreover, the wireless repeater apparatus is characterized in that,

wherein the wireless repeater apparatus further comprises antenna selection information storing means for storing antenna selection information indicating the antenna that has been selected by the antenna selecting means when the communication signal is received from the wireless communication apparatus,

wherein when newly receiving a communication signal from the wireless communication apparatus, the wireless repeater apparatus control means reads the antenna selection information from the antenna selection information storing means, and switches the antenna selecting means based on the read antenna selection information, so as to select one antenna of each of the antenna set.

Further, the wireless repeater apparatus is characterized in that,

wherein each of the antenna set comprises a plurality of antenna pairs each including one transmitting antenna and one receiving antenna corresponding to each other,

wherein the antenna selecting means selects, upon selecting one receiving antenna of each of the antenna set, one transmitting antenna corresponding to the selected receiving antenna.

Furthermore, the wireless repeater apparatus is characterized in that,

wherein with respect to each of the antenna pairs, a coverage area of the transmitting antenna and a coverage area of the receiving antenna mutually overlap, and coverage areas of the different transmitting antennas do not mutually overlap.

According to a fifth aspect of the present invention, the wireless repeater apparatus of the first aspect of the present invention is further characterized in that, wherein the wireless repeater apparatus further comprises:

at least one antenna set comprised of antennas sharing the same identifier of the antenna, among the plurality of antennas,

antenna selecting means switchable to select one antenna of each of the antenna set, and

feedback receiving means for receiving, when the antenna selecting means is switched to select one antenna of each of the antenna set, a feedback signal that contains reception state information of the communication signal transmitted through the selected antenna and received by a wireless communication apparatus, from the wireless communication apparatus, and

wherein when the antenna selecting means is switched to select one antenna of each of the antenna set, the wireless repeater apparatus control means further transmits the communication signal to the wireless communication apparatus through the selected antenna, and controls the antenna selecting means based on the reception state information contained in the received feedback signal, so that the communication signal is received by the wireless communication apparatus.

The wireless repeater apparatus is characterized in that,

wherein the reception state information includes at least one of a reception level of the communication signal, a reception result of the communication signal, information of an antenna switching state of an antenna selecting means provided in the wireless communication apparatus, and the communication signal received by the wireless communication apparatus.

Moreover, the wireless repeater apparatus is characterized in that,

wherein the wireless repeater apparatus further comprises antenna selection information storing means for storing antenna selection information indicating the antenna that has been selected by the antenna selecting means when the communication signal is received by the wireless communication apparatus,

wherein when newly transmitting a communication signal to the wireless communication apparatus, the wireless repeater apparatus control means reads the antenna selection information from the antenna selection information storing means, and switches the antenna selecting means based on the read antenna selection information, so as to select one antenna of each of the antenna set.

Further, the wireless repeater apparatus is characterized in that,

wherein each of the antenna set comprises a plurality of antenna pairs each including one transmitting antenna and one receiving antenna corresponding to each other,

wherein the antenna selecting means selects, upon selecting one transmitting antenna of each of the antenna set, one receiving antenna corresponding to the selected transmitting antenna.

Furthermore, the wireless repeater apparatus is characterized in that,

wherein with respect to each of the antenna pairs, a coverage area of the transmitting antenna and a coverage area of the receiving antenna mutually overlap, and coverage areas of the different transmitting antennas do not mutually overlap.

According to a sixth aspect of the present invention, a wireless communication apparatus for communicating with the wireless repeater apparatus of the first aspect of the present invention is provided, the wireless communication apparatus comprising:

at least one antenna set comprised of antennas,

antenna selecting means switchable to select one antenna of each of the antenna set,

feedback receiving means for receiving, when the antenna selecting means is switched to select one antenna of each of the antenna set, a feedback signal that contains reception state information of the communication signal transmitted through the selected antenna and received by the wireless repeater apparatus, from the wireless repeater apparatus, and

wireless communication apparatus control means for controlling the antenna selecting means,

wherein when the antenna selecting means is switched to select one antenna of each of the antenna set, the wireless communication apparatus control means further transmits the communication signal to the wireless repeater apparatus through the selected antenna, and controls the antenna selecting means based on the reception state information contained in the received feedback signal, so that the communication signal is received by the wireless repeater apparatus.

The wireless communication apparatus is characterized in that,

wherein the reception state information includes at least one of a reception level of the communication signal, a reception result of the communication signal, information of an antenna switching state of an antenna selecting means provided in the wireless repeater apparatus, and the communication signal received by the wireless repeater apparatus.

Moreover, the wireless communication apparatus is characterized in that,

wherein the wireless communication apparatus further comprises antenna selection information storing means for storing antenna selection information indicating the antenna that has been selected by the antenna selecting means when the communication signal is received by the wireless repeater apparatus, and

wherein when newly transmitting a communication signal to the wireless repeater apparatus, the wireless communication apparatus control means reads the antenna selection information from the antenna selection information storing means, and switches the antenna selecting means based on the read antenna selection information, so as to select one antenna of each of the antenna set.

Further, the wireless communication apparatus is characterized in that,

wherein each of the antenna set comprises a plurality of antenna pairs each including one transmitting antenna and one receiving antenna corresponding to each other, and

wherein the antenna selecting means selects, upon selecting one transmitting antenna of each of the antenna set, one receiving antenna corresponding to the selected transmitting antenna.

Furthermore, the wireless communication apparatus is characterized in that,

wherein with respect to each of the antenna pairs, a coverage area of the transmitting antenna and a coverage area of the receiving antenna mutually overlap, and coverage areas of the different transmitting antennas do not mutually overlap.

According to a seventh aspect of the present invention, a wireless communication apparatus for communicating with the wireless repeater apparatus of the first aspect of the present invention is provided, the wireless communication apparatus comprising:

at least one antenna set comprised of antennas,

antenna selecting means switchable to select one antenna of each of the antenna set,

feedback transmitting means for transmitting, when the antenna selecting means is switched to select one antenna of each of the antenna set, a feedback signal that contains reception state information of the communication signal transmitted from the wireless repeater apparatus and received through the selected antenna, to the wireless repeater apparatus, and

wireless communication apparatus control means for controlling the antenna selecting means,

wherein the wireless communication apparatus control circuit further controls the antenna selecting means based on the reception state information of the communication signal, to receive the communication signal transmitted from the wireless repeater apparatus.

The wireless communication apparatus is characterized in that,

wherein the reception state information includes at least one of a reception level of the communication signal, a reception result of the communication signal, information of an antenna switching state of the antenna selecting means, and the communication signal received by the wireless communication apparatus.

Moreover, the wireless communication apparatus is characterized in that,

wherein the wireless communication apparatus further comprises antenna selection information storing means for storing antenna selection information indicating the antenna that has been selected by the antenna selecting means when the communication signal is received from the wireless repeater apparatus, and

wherein when newly receiving a communication signal from the wireless repeater apparatus, the wireless communication apparatus control means reads the antenna selection information from the antenna selection information storing means, and switches the antenna selecting means based on the read antenna selection information, so as to select one antenna of each of the antenna set.

Further, the wireless communication apparatus is characterized in that,

wherein each of the antenna set comprises a plurality of antenna pairs each including one transmitting antenna and one receiving antenna corresponding to each other, and

wherein the antenna selecting means selects, upon selecting one receiving antenna of each of the antenna set, one transmitting antenna corresponding to the selected receiving antenna.

Furthermore, the wireless communication apparatus is characterized in that,

wherein with respect to each of the antenna pairs, a coverage area of the transmitting antenna and a coverage area of the receiving antenna mutually overlap, and coverage areas of the different transmitting antennas do not mutually overlap.

According to the wireless communication system of the present invention, the wireless communication apparatus and the wireless repeater apparatus can automatically set their communication directions. Additionally, the wireless communication apparatus performs its communication via the wireless repeater apparatus, and its remote party to which the wireless communication apparatus directly communicate is not changed from the wireless repeater apparatus even when the wireless communication apparatus communicates with another party of communication, and accordingly, it is not necessary to newly set the communication direction even when the wireless communication apparatus changes its remote party of communication, thus improving the convenience of the user.

### BRIEF DESCRIPTION OF THE DRAWINGS

FIG. 1 is an overview showing a prior art wireless communication system;

FIG. 2 is a block diagram showing an exemplary operation of the prior art wireless communication system;

FIG. 3 is a block diagram of a wireless communication system according to a first preferred embodiment of the present invention;

FIG. 4 is a block diagram showing the detailed configuration of a wireless repeater apparatus 302 of FIG. 3;

FIG. 5A is a sequence chart showing a first exemplary operation of packet relaying action executed in the wireless communication system of FIG. 3;

FIG. 5B is a sequence chart showing a second exemplary operation of the packet relaying action executed in the wireless communication system of FIG. 3;

FIG. 6 is a sequence chart showing an exemplary operation of correspondence table memory managing action executed in the wireless communication system of FIG. 3;

FIG. 7 is a flow chart showing a first part of packet relaying process executed by a wireless repeater apparatus control circuit 404 of FIG. 4;

FIG. 8 is a flow chart showing a second part of the packet relaying process executed by the wireless repeater apparatus control circuit 404 of FIG. 4;

FIG. 9 is a flow chart showing a source address extracting process (step S3) that is a subroutine of FIG. 7;

FIG. 10 is a flow chart showing a correspondence table memory managing process executed by the wireless repeater apparatus control circuit 404 of FIG. 4;

FIG. 11 is a block diagram of a wireless communication system according to a second preferred embodiment of the present invention;

FIG. 12 is a plan view showing in detail coverage areas in the wireless communication system of FIG. 11;

FIG. 13 is a pattern map for explaining antenna directivities in the wireless communication system of FIG. 11;

FIG. 14 is a block diagram showing the detailed configurations of a wireless communication apparatus 301a and a wireless repeater apparatus 302a of FIG. 11;

FIG. 15 is a flow chart showing an antenna controlling process executed by an antenna control circuit 709 of the wireless repeater apparatus 302a of FIG. 14;

FIG. 16 is a flow chart showing an antenna controlling process executed by an antenna control circuit 701 of the wireless communication apparatus 301a of FIG. 14;

FIG. 17 is a flow chart showing an antenna managing process executed by the antenna control circuit 709 of the wireless repeater apparatus 302a of FIG. 14;

FIG. 18 is a flow chart showing an antenna managing process executed by the antenna control circuit 701 of the wireless communication apparatus 301a of FIG. 14;

FIG. 19 is a flow chart showing a modified preferred embodiment of an antenna managing process executed by the antenna control circuit 709 of the wireless repeater apparatus 302a of FIG. 14;

FIG. 20 is a flow chart showing a modified preferred embodiment of an antenna managing process executed by the antenna control circuit 701 of the wireless communication apparatus 301a of FIG. 14; and

FIG. 21 is a sequence chart showing a monitoring action executed in the wireless communication system of FIG. 11.

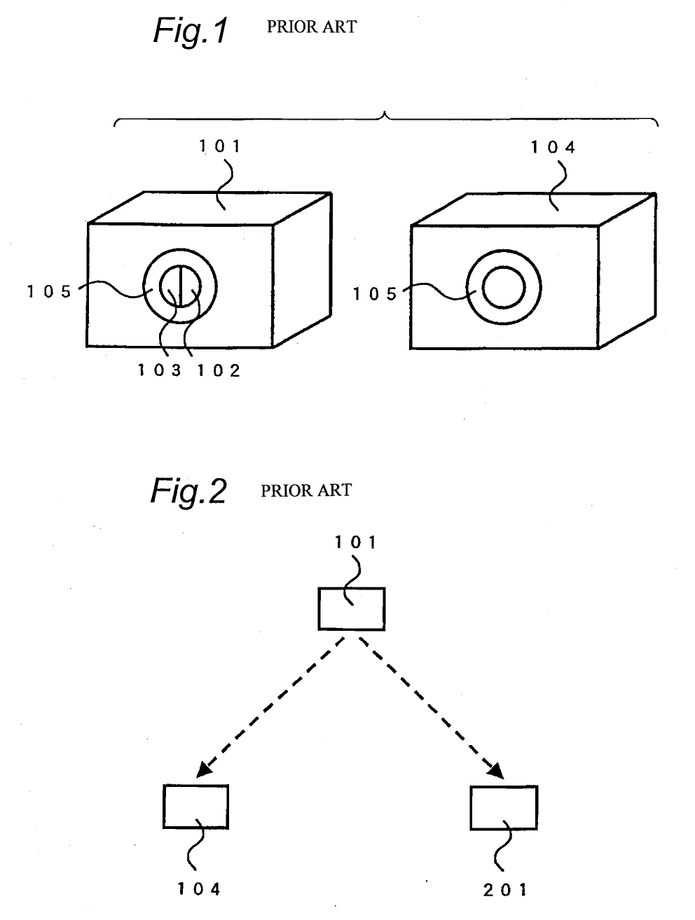

### DESCRIPTION OF REFERENCE NUMERALS

301, 301a, 303, 30: wireless communication apparatus,
302, 302a: wireless repeater apparatus,
304: correspondence table memory,
305, 307, 310, 501, 504, 507, 512, 515, 518: receiving antennas,
306, 308, 311, 502, 505, 508, 513, 516, 519: transmitting antenna,
312, 313, 314, 510, 521: antenna,
401, 409, 414, 713, 715, 716, 720, 721, 722: receiver circuit,
402, 410, 415, 702, 710: memory,
403, 411, 416: memory control circuit,
404: wireless repeater apparatus control circuit,
405: switching control circuit,
406: switching circuit,
408, 413, 418, 705, 706, 707, 723, 724, 725: transmitter circuit,
420, 708, 712: timer circuit,
503, 506, 509, 511, 514, 517, 520, 522, 523, 602, 604, 605: coverage area,
510a, 521a: circulator,
601, 603: installation position,
701, 709: antenna control circuit,
703, 711, 718, 719, SW1-SW9: switch,
704: wireless communication apparatus control circuit,
714a, 717a: feedback transmitter circuit, and
717b, 717b: feedback receiver circuit.

### DETAILED DESCRIPTION OF THE PREFERRED EMBODIMENTS

The best modes for implementing the present invention are described below with reference to the drawings.

### First Preferred Embodiment

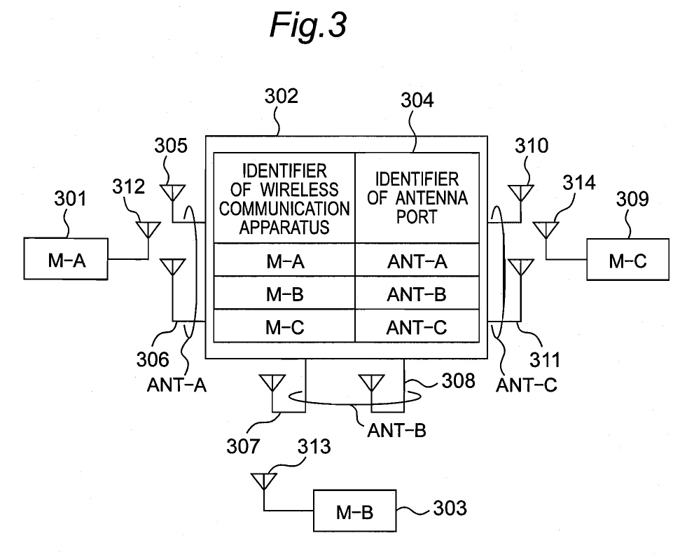

FIG. 3 is a block diagram of a wireless communication system according to the first preferred embodiment of the present invention. The wireless communication system is constituted of wireless communication apparatuses 301, 303 and 309, and a wireless repeater apparatus 302 that relays communications among these wireless communication apparatuses 301, 303 and 309. It is assumed that the wireless communication apparatuses 301, 303, 309 and the wireless repeater apparatus 302 use as a wireless medium an electromagnetic wave such as a millimeter wave etc., that has a very straight propagation property. Then, it is assumed that the wireless communication apparatus 301 has an antenna 312 and its own identifier M-A, the wireless communication apparatus 303 has an antenna 313 and its own identifier M-B, and the wireless communication apparatus 309 has an antenna 314 and its own identifier M-C. For example, an MAC address or the like can be used for the identifiers of the wireless communication apparatuses 301, 303, 309. The wireless repeater apparatus 302 is constituted of a plurality of transmitting antennas 306, 308 and 311, and a plurality of receiving antennas 305, 307 and 310. The transmitting antenna 306 and the receiving antenna 305 are provided mutually adjacently so as to be directed at a certain azimuth, and used as an antenna port for communicating with a certain wireless communication apparatus. Likewise, the transmitting antenna 308 and the receiving antenna 307 are provided mutually adjacently so as to be directed at a certain azimuth, and used as an antenna port for communicating with a certain wireless communication apparatus. Moreover, the transmitting antenna 311 and the receiving antenna 310 are provided mutually adjacently so as to be directed at a certain azimuth, and used as an antenna port for communicating with a certain wireless communication apparatus. Moreover, an antenna port identifier ANT-A is assigned to the antennas 305 and 306, an antenna port identifier ANT-B is assigned to the antennas 307 and 308, and an antenna port identifier ANT-C is assigned to the antennas 310 and 311. The wireless repeater apparatus 302 is further provided with a correspondence table memory 304 that stores a correspondence table including relations in which each antenna port identifier is correspondingly associated with the identifier of the wireless communication apparatus communicatable by using each one the antenna ports, in a one by one manner.

The wireless repeater apparatus 302 relays the communications among the wireless communication apparatuses 301, 303 and 309, as described in detail later. For example, when the wireless communication apparatus 301 having the identifier M-A communicates with the wireless communication apparatus 303 having the identifier M-B via the wireless repeater apparatus 302, the wireless repeater apparatus 302 executes a relaying process with reference to the correspondence table memory 304, and thereby, for example, transmit a communication response signal (e.g., an acknowledgment (ACK) signal or a negative acknowledgment (NACK) signal) to the wireless communication apparatus 301 on behalf of the wireless communication apparatus 303, or transmit the communication response signal to the wireless communication apparatus 303 on behalf of the wireless communication apparatus 301.

Particularly, the correspondence table memory 304 stores a relation in which the identifier M-A of the wireless communication apparatus 301 is correspondingly associated with the identifier ANT-A of the antenna port pertaining to the antennas 305 and 306, in order to specify the antenna port to be used when the wireless repeater apparatus 302 communicates with the wireless communication apparatus 301. Likewise, the correspondence table memory 304 stores a relation in which the identifier M-B of the wireless communication apparatus 303 is correspondingly associated with the identifier ANT-B of the antenna port pertaining to the antennas 307 and 308, in order to specify the antenna port to be used when the wireless repeater apparatus 302 communicates with the wireless communication apparatus 303. Further, the correspondence table memory 304 stores a relation in which the identifier M-C of the wireless communication apparatus 309 is correspondingly associated with the identifier ANT-C of the antenna port pertaining to the antennas 310 and 311, in order to specify the antenna port to be used when the wireless repeater apparatus 302 communicates with the wireless communication apparatus 309.

Similarly, when the wireless communication apparatus 301 communicates with the wireless communication apparatus 309 or when the wireless communication apparatus 303 communicates with the wireless communication apparatus 309, the communications are performed via the wireless repeater apparatus 302, and the wireless repeater apparatus 302 executes the process for relaying by looking up the correspondence table memory 304.

For example, when transmitting data from the wireless communication apparatus 301 to the wireless communication apparatus 303, the wireless repeater apparatus 302 looks up the correspondence table memory 304 for the identifier M-B of the wireless communication apparatus 303 that is the destination of received data packets upon receiving data packets from the wireless communication apparatus 301 through the antenna 305, sends the received data packets to the transmitting antenna 308 associated with the identifier ANT-B of the antenna port corresponding to the identifier M-B, and transmits the data packets to the wireless communication apparatus 303 through the transmitting antenna 308. By carrying out the similar process, the wireless repeater apparatus 302 is able to relay the data packets transmitted from the wireless communication apparatus 301 to the wireless communication apparatus 309, to relay the data packets transmitted from the wireless communication apparatus 303 to either the wireless communication apparatus 301 or 309, and to relay the data packets transmitted from the wireless communication apparatus 309 to either the wireless communication apparatus 301 or 303.

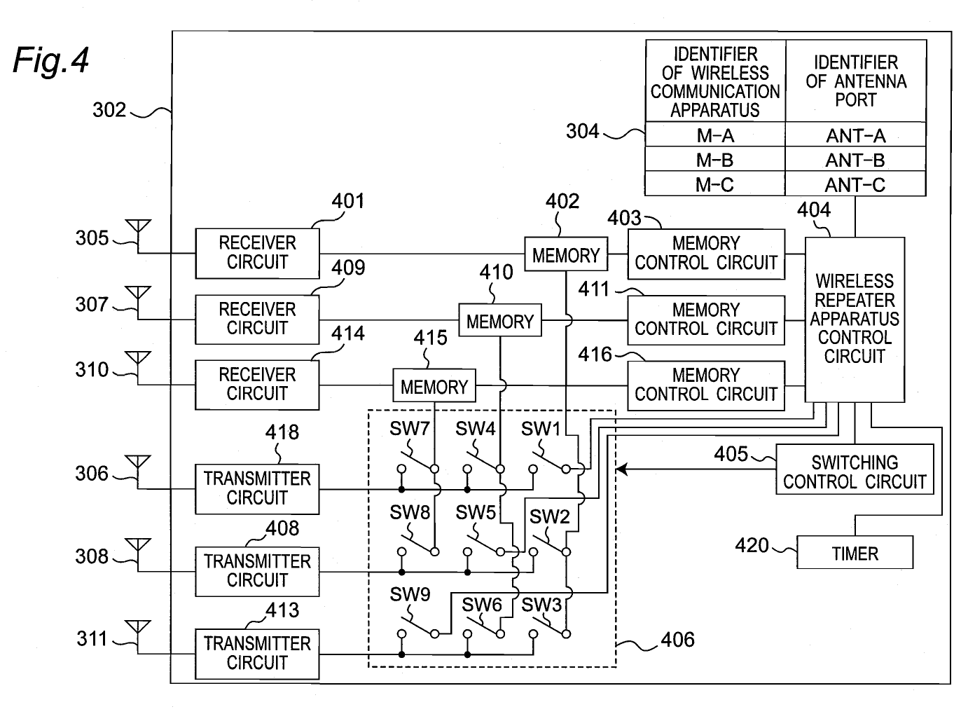

FIG. 4 is a block diagram showing the detailed configuration of the wireless repeater apparatus 302 of FIG. 3. In FIG. 4, the same components as those of FIG. 3 are denoted by the same reference numerals, and are not described again.

Referring to FIG. 4, in the wireless repeater apparatus 302, the receiving antennas 305, 307 and 310 are respectively connected to input terminals of memories 402, 410 and 415 through wireless receiver circuits (hereinafter referred to as “receiver circuits”) 401, 409 and 414, and output terminals of the memories 402, 410 and 415 are connected to the transmitting antennas 306, 308 and 311 through a switching circuit 406 and wireless transmitter circuits (hereinafter referred to as “transmitter circuits”) 418, 408 and 413. The wireless repeater apparatus 302 is further provided with the correspondence table memory 304, memory control circuits 403, 411 and 416 that respectively control the memories 402, 410 and 415, a switching control circuit 405 that controls the switching of the switching circuit 406, a timer circuit 420, and a wireless repeater apparatus control circuit 404 that controls these components.

In FIG. 4, when a data packet is received through the receiving antenna 305, the received data packet is inputted to the receiver circuit 401, and the receiver circuit 401 executes an amplifying process and a detecting process etc. of the data packet, and temporarily stores the processed data packet to the memory 402. Then, the memory control circuit 403 extracts the identifier of the wireless communication apparatus corresponding to the destination of the data packet, from the data packets stored in the memory 402, and send the same to the wireless repeater apparatus control circuit 404. Likewise, when a data packet is received through the receiving antenna 307, the received data packet is inputted to the receiver circuit 409, and the receiver circuit 409 executes an amplifying process and a detecting process etc. of the data packet, and temporarily stores the processed data packet to the memory 410. Then, the memory control circuit 411 extracts the identifier of the wireless communication apparatus corresponding to the destination of the data packet, from data packets stored in the memory 410, and sends the same to the wireless repeater apparatus control circuit 404. When a data packet is received through the receiving antenna 310, the received data packet is inputted to the receiver circuit 414, and the receiver circuit 414 executes an amplifying process and a detecting process etc. of the data packet, and temporarily stores the processed data packet to the memory 415. Then, the memory control circuit 416 extracts the identifier of the wireless communication apparatus corresponding to the destination of the data packet, from the data packets stored in the memory 415, and sends the same to the wireless repeater apparatus control circuit 404.

The wireless repeater apparatus control circuit 404 obtains the identifier of the corresponding antenna port by looking up the correspondence table memory 304 based on the identifier of the destination wireless communication apparatus sent from the memory control circuits 403, 411 and 416. The wireless repeater apparatus control circuit 404 sends the obtained antenna port identifier to the switching control circuit 405, and the switching control circuit 405 controls the switching circuit 406 to turn on only the corresponding switch of the switching circuit 406, based on the antenna port identifier sent from the wireless repeater apparatus control circuit 404.

The switching circuit 406 is constituted of switches SW1 to SW9, as shown in FIG. 4. When relaying the data packet, the switching control circuit 405 makes a connection by turning on the switch SW2 or SW3, so as to transfer the data packets temporarily stored in the memory 402 to the transmitter circuit 408 or 413, makes a connection by turning on the switch SW4 or SW6, so as to transfer the data packets temporarily stored in the memory 410 to the transmitter circuit 418 or 413, and makes a connection by turning on the switch SW7 or SW8, so as to transfer the data packets temporarily stored in the memory 415 to the transmitter circuit 418 or 408. On the other hand, when packets originated from the wireless repeater apparatus 302 needs to be transmitted to the wireless communication apparatuses 301, 303, 309 instead of the data packets to be relayed, the switching control circuit 405 makes a connection by turning on any one of the switches SW1, SW5 and SW9, so as to transfer packets generated by the wireless repeater apparatus control circuit 404 to any one of the transmitter circuits 418, 408, 413. The cases where the packets originated from the wireless repeater apparatus 302 needs to be transmitted to the wireless communication apparatuses 301, 303, 309 includes, for example, a case where no ACK packet is returned even though the data packet to be relayed is transmitted to the destination wireless communication apparatus (i.e., when the relaying of the data packet fails), and a case where the wireless repeater apparatus 302 monitors the wireless communication apparatuses around the wireless repeater apparatus 302 for maintaining and updating the correspondence table memory 304, as described in detail later.

The wireless repeater apparatus control circuit 404 makes the switching control circuit 405 switch the connection of the switching circuit 406, and makes the memory control circuit 403 control the memory 402 so as to transfer the data packets temporarily stored in the memory 402 to the transmitter circuit 408 or 413 through the switching circuit 406. Likewise, the wireless repeater apparatus control circuit 404 makes the memory control circuit 411 control the memory 410 so as to transfer the data packets temporarily stored in the memory 410 to the transmitter circuit 418 or 413 through the switching circuit 406, and makes the memory control circuit 416 control the memory 415 so as to transfer the data packets temporarily stored in the memory 415 to the transmitter circuit 418 or 408 through the switching circuit 406.

The transmitter circuit 418 executes an amplifying process etc. of the data packets transferred from the switching circuit 406, and transmits the processed data packets through the transmitting antenna 306. Likewise, the transmitter circuit 408 executes an amplifying process etc. of the data packets transferred from the switching circuit 406, and transmits the processed data packets through the transmitting antenna 308. Moreover, the transmitter circuit 413 executes an amplifying process etc. of the data packets transferred from the switching circuit 406, and transmits the processed data packets through the transmitting antenna 311.

In the present preferred embodiment, the correspondence table memory 304 records the identifiers of the wireless communication apparatus with which the wireless repeater apparatus 302 can communicate, and the wireless repeater apparatus 302 updates this recorded information as follows.

The correspondence table memory 304 is in a empty state at its initial state, in which the information of the identifiers of the wireless communication apparatuses corresponding to the antenna port identifiers ANT-A, ANT-B, ANT-C is not stored. If the correspondence table memory 304 is in the empty state, then a user of the wireless repeater apparatus 302 may input the identifier of an appropriate wireless communication apparatus; or alternatively, when the wireless repeater apparatus 302 receives a packet, the wireless repeater apparatus control circuit 404 may update the correspondence table memory 304 based on the identifier of the source wireless communication apparatus of the packet, as described later; or alternatively, the wireless repeater apparatus control circuit 404 may update the correspondence table memory 304 by monitoring the wireless communication apparatuses around the wireless repeater apparatus 302. On the other hand, if the correspondence table memory 304 stores several identifiers of the wireless communication apparatuses, then upon receiving a packet, the wireless repeater apparatus control circuit 404 may update the correspondence table memory 304 based on the identifier of the source wireless communication apparatus of the packet; or alternatively, the wireless repeater apparatus control circuit 404 may update the correspondence table memory 304 by monitoring the wireless communication apparatuses around the wireless repeater apparatus 302.

When a packet is received from the wireless communication apparatuses 301, 303 and 309, the wireless repeater apparatus control circuit 404 of the wireless repeater apparatus 302 updates the correspondence table memory 304 based on this packet. In such a condition that the identifier of the wireless communication apparatus corresponding to the identifier of a certain antenna port is not recorded in the correspondence table memory 304, the wireless repeater apparatus control circuit 404 of the wireless repeater apparatus 302 updates the information recorded in the correspondence table memory 304, based on the data packet received from any one of the wireless communication apparatuses 301, 303 and 309, in the following manner. For example, when a data packet is received through the receiving antenna 305, the memory control circuit 403 extracts the identifier of the source wireless communication apparatus from the data packet that has been received and stored in the memory 402, and sends the identifier to the wireless repeater apparatus control circuit 404. The wireless repeater apparatus control circuit 404 records the extracted identifier in the correspondence table memory 304 as the identifier of the wireless communication apparatus corresponding to the antenna port identifier ANT-A pertaining to the antenna 305. Likewise, when a data packet is received through the receiving antenna 307, the memory control circuit 411 extracts the identifier of the source wireless communication apparatus from the data packet that has been received and stored in the memory 410, and sends the identifier to the wireless repeater apparatus control circuit 404, and the wireless repeater apparatus control circuit 404 records the extracted identifier in the correspondence table memory 304 as the identifier of the wireless communication apparatus corresponding to the antenna port identifier ANT-B pertaining to the antenna 307. Moreover, when a data packet is received through the receiving antenna 310, the memory control circuit 416 extracts the identifier of the source wireless communication apparatus from the data packet that has been received and stored in the memory 415, and the wireless repeater apparatus control circuit 404 records the extracted identifier in the correspondence table memory 304 as the identifier of the wireless communication apparatus corresponding to the antenna port identifier ANT-C pertaining to the antenna 310.

According to the configuration of the wireless repeater apparatus 302 of the present preferred embodiment, the receiving antenna 305 is paired with the transmitting antenna 306, the receiving antenna 307 is paired with the transmitting antenna 308, and the receiving antenna 310 is paired with the transmitting antenna 311, as described above. When a signal transmitted from the wireless communication apparatus 301 is received through, e.g., the receiving antenna 305, the wireless repeater apparatus 302 uses the transmitting antenna 306 when transmitting a signal to the wireless communication apparatus 301. Therefore, the identifier M-A of the wireless communication apparatus 301 is recorded in the correspondence table memory 304 so as to correspond to the antenna port identifier ANT-A pertaining to the receiving antenna 305 and the transmitting antenna 306. Likewise, in the correspondence table memory 304 of the configuration of the wireless communication system shown in FIG. 3, the identifier M-B of the wireless communication apparatus 303 is recorded so as to correspond to the antenna port identifier ANT-B, and the identifier M-C of the wireless communication apparatus 309 is recorded so as to correspond to the antenna port identifier ANT-C.

Alternatively, the wireless repeater apparatus control circuit 404 of the wireless repeater apparatus 302 may detect whether the wireless communication apparatus 301, 303, 309 is in a communicatable status or in an uncommunicatable status, and update the correspondence table memory 304 based on the detection result, not when receiving a packet from the wireless communication apparatus 301, 303, 309, but when transmitting a packet to the wireless communication apparatuses 301, 303, 309. Particularly, the wireless repeater apparatus control circuit 404 transmits the data packet from any one of the transmitting antennas 306, 308 and 311, and starts counting in the timer circuit 420 to wait to receive an ACK packet for the transmitted data packet through the receiving antenna, paired with the transmitting antenna that transmitted the data packet, among the receiving antennas 305, 307, 310. When the ACK packet is received within a predetermined timeout duration, the wireless repeater apparatus control circuit 404 stores the identifier of the source wireless communication apparatus of the ACK packet to the correspondence table memory 304, so as to be correspondingly associated with the identifier of the antenna port pertaining to the used transmitting antenna and receiving antenna. On the other hand, when no ACK packet is received within the timeout duration, the wireless repeater apparatus control circuit 404 updates the correspondence table memory 304 so that the identifier of the wireless communication apparatus corresponding to the identifier of the antenna port pertaining to the used transmitting antenna and receiving antenna becomes blank in the correspondence table memory 304.

Therefore, when updating the correspondence table memory 304 with respect to, e.g., the identifier ANT-A of the antenna port pertaining to the antennas 305 and 306, the wireless repeater apparatus control circuit 404 transmits a data packet from the transmitting antenna 306, starts counting in the timer circuit 420 to wait to receive an ACK packet for the transmitted data packet through the receiving antenna 305 paired with the transmitting antenna 306. When the ACK packet is received through the receiving antenna 305 within a predetermined timeout duration, the wireless repeater apparatus control circuit 404 stores the identifier of the source wireless communication apparatus of the ACK packet to the correspondence table memory 304, so as to be correspondingly associated with the identifier ANT-A of the antenna port pertaining to the antennas 305, 306. On the other hand, when no ACK packet is received through the receiving antenna 305 within the timeout duration, the wireless repeater apparatus control circuit 404 updates the correspondence table memory 304 so that the identifier of the wireless communication apparatus corresponding to the antenna port identifier ANT-A becomes blank in the correspondence table memory 304. Similar process is performed when updating the correspondence table memory 304 for the identifier ANT-B of the antenna port pertaining to the antennas 307 and 308, and for the identifier ANT-C of the antenna port pertaining to the antennas 310 and 311.

Moreover, in order to maintain the contents of the correspondence table memory 304, the wireless repeater apparatus control circuit 404 makes the switching control circuit 405 control the switching circuit 406 to turn on a switch for connection to a transmitting antenna of a selected certain antenna port among the switches SW1, SW5, SW9 of the switching circuit 406, and transmits a data packet having the address of the wireless repeater apparatus 302 as the source address and having the identifier of a certain wireless communication apparatus as the destination address, during a period, e.g., in which the receiver circuit connected to the receiving antenna of the selected antenna port does not perform the receiving process, in which the transmitter circuit connected to the transmitting antenna of the selected antenna port does not perform the transmitting process, or in which the wireless repeater apparatus control circuit 404 is not sending the identifier of the selected antenna port to the switching control circuit 405. In this case, the identifier of the wireless communication apparatus corresponding to the identifier of the selected antenna port in the correspondence table memory 304 can be used as the destination address of the data packet to be transmitted. At the same time as transmitting the data packet, the wireless repeater apparatus control circuit 404 starts counting in the timer circuit 420. If a communication response signal that has the address of the wireless repeater apparatus 302 as the destination address is received from the wireless communication apparatus 301 before the timeout duration elapses in the timer circuit 420, then the wireless repeater apparatus control circuit 404 determines that the wireless communication apparatus specified by the identifier of the wireless communication apparatus corresponding to the identifier of the selected antenna port in the correspondence table memory 304 is communicatable. On the other hand, if the communication response signal from the wireless communication apparatus is not received before the timeout duration elapses in the timer circuit 420, then the wireless repeater apparatus control circuit 404 determines that the wireless communication apparatus specified by the identifier of the wireless communication apparatus corresponding to the identifier of the selected antenna port in the correspondence table memory 304 is uncommunicatable, and deletes the identifier of the wireless communication apparatus corresponding to the antenna port identifier from the correspondence table memory 304.

Therefore, for example, when maintaining the contents of the correspondence table memory 304 with respect to the antenna port identifier ANT-A, the switching control circuit 405 controls the switching circuit 406 to turn on the switch SW1 of the switching circuit 406, and a data packet having the address of the wireless repeater apparatus 302 as the source address and having the identifier of a certain wireless communication apparatus as the destination address is transmitted through the transmitter circuit 418 and the transmitting antenna 306, during a period in which the receiver circuit 401 connected to the receiving antenna 305 does not perform the receiving process, in which the transmitter circuit 418 connected to the transmitting antenna 306 does not perform the transmitting process, or in which the wireless repeater apparatus control circuit 404 is not sending the antenna port identifier ANT-A to the switching control circuit 405. In this case, the identifier M-A of the wireless communication apparatus 301 corresponding to the antenna port identifier ANT-A in the correspondence table memory 304 can be used as the destination address of the data packet to be transmitted. At the same time as transmitting the data packet, the wireless repeater apparatus control circuit 404 starts counting in the timer circuit 420. If a communication response signal that has the address of the wireless repeater apparatus 302 as the destination address is received from the wireless communication apparatus 301 before the timeout duration elapses in the timer circuit 420, then the wireless repeater apparatus control circuit 404 determines that the wireless communication apparatus 301 specified by the identifier M-A of the wireless communication apparatus corresponding to the antenna port identifier ANT-A in the correspondence table memory 304 is communicatable. On the other hand, if the communication response signal from the wireless communication apparatus 301 is not received before the timeout duration elapses in the timer circuit 420, then the wireless repeater apparatus control circuit 404 determines that the wireless communication apparatus 301 specified by the identifier M-A of the wireless communication apparatus corresponding to the antenna port identifier ANT-A in the correspondence table memory 304 is uncommunicatable, and deletes the identifier M-A of the wireless communication apparatus corresponding to the antenna port identifier ANT-A from the correspondence table memory 304.

Similar process is performed when maintaining the contents of the correspondence table memory 304 with respect to the antenna port identifiers ANT-B and ANT-C.

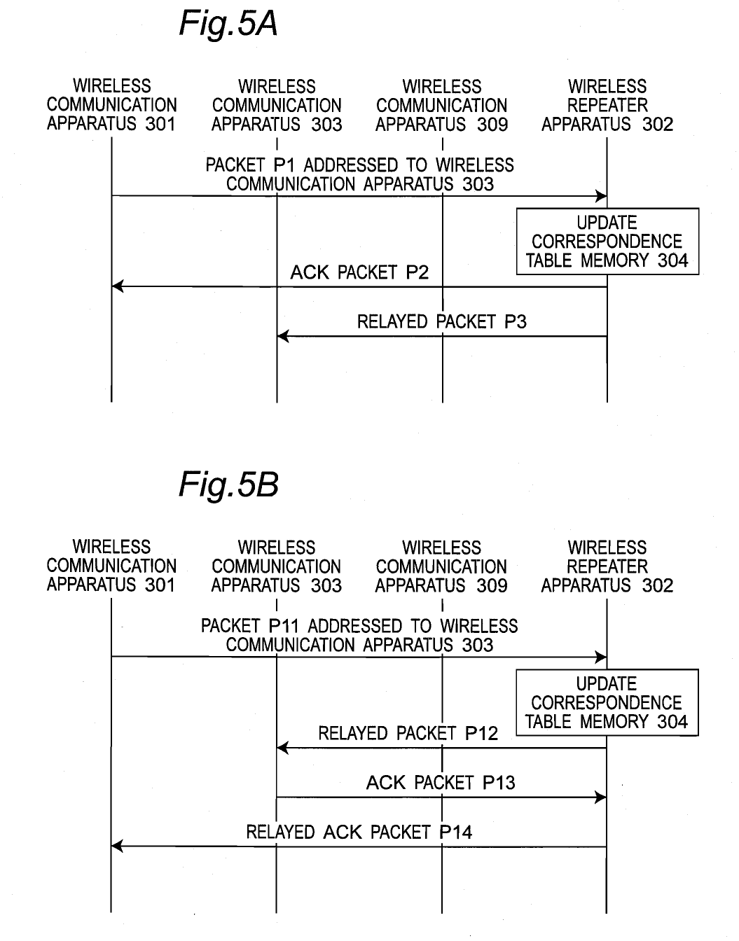

Exemplary implementations of the updating of the correspondence table memory 304 described above are described with reference to FIGS. 5A and 5B. FIG. 5A shows the first exemplary operation of packet relaying action executed in the wireless communication system of FIG. 3, and FIG. 5B is a sequence chart showing the second exemplary operation of the packet relaying action executed in the wireless communication system of FIG. 3. These exemplary operations are to update the correspondence table memory 304 when a packet to be relayed is received from any one of the wireless communication apparatuses 301, 303, 309. Referring to FIG. 5A, when the wireless repeater apparatus 302 receives a packet P1 transmitted by the wireless communication apparatus 301 and addressed to the wireless communication apparatus 303, through any one of the receiving antennas, the wireless repeater apparatus 302 extracts the identifier M-A of the source wireless communication apparatus 301 from the received packet P1, and updates the correspondence table memory 304 so as to store the extracted identifier M-A as the identifier of the wireless communication apparatus corresponding to the identifier of the antenna port pertaining to the receiving antenna. Then, the wireless repeater apparatus 302 returns an ACK packet P2 to the wireless communication apparatus 301 on behalf of the destination wireless communication apparatus 303, and subsequently transmits a packet P3 to be relayed to the destination wireless communication apparatus 303.

The ACK packet may be transmitted from the wireless repeater apparatus 302 to the wireless communication apparatus 301 after the ACK packet from the destination wireless communication apparatus 303 is received. Referring to FIG. 5B, when the wireless repeater apparatus 302 receives a packet P11 transmitted by the wireless communication apparatus 301 and addressed to the wireless communication apparatus 303, through any one of the receiving antennas, the wireless repeater apparatus 302 extracts the identifier M-A of the source wireless communication apparatus 301 from the received packet P1, and updates the correspondence table memory 304 so as to store the extracted identifier M-A as the identifier of the wireless communication apparatus corresponding to the identifier of the antenna port pertaining to the receiving antenna. Then, the wireless repeater apparatus 302 transmits a packet P12 to be relayed to the destination wireless communication apparatus 303, receives an ACK packet P13 from the wireless communication apparatus 303, and thereafter sends an ACK packet P14 back to the wireless communication apparatus 301 on behalf of the destination wireless communication apparatus 303, thus relays the ACK packet from the destination wireless communication apparatus 303.

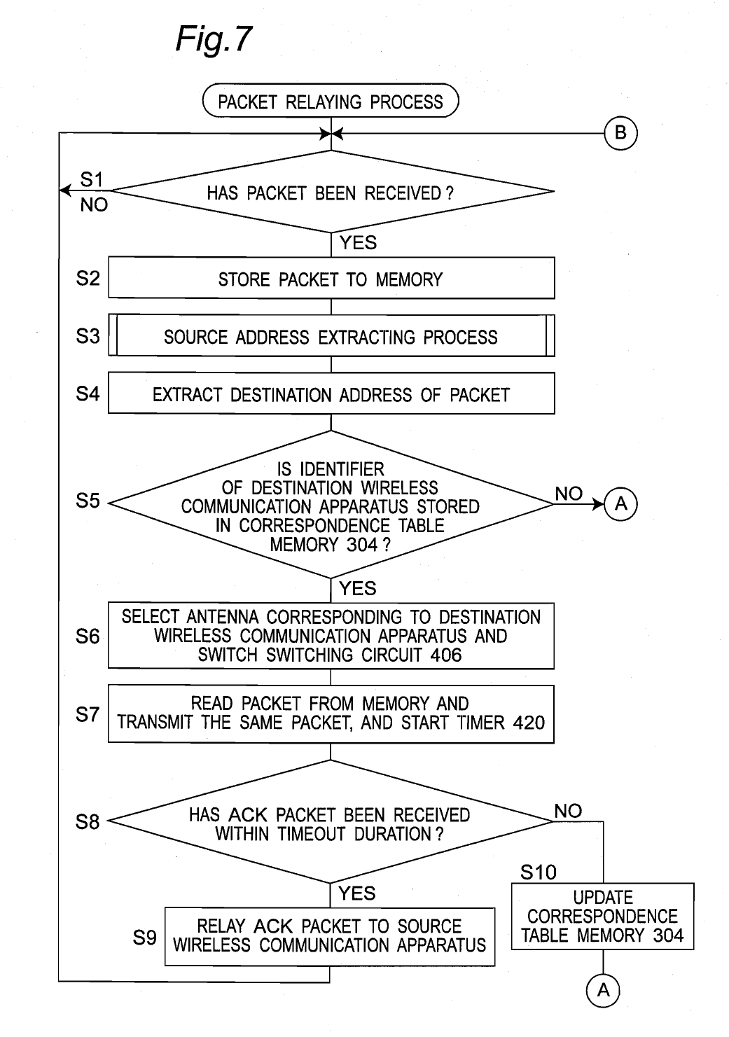

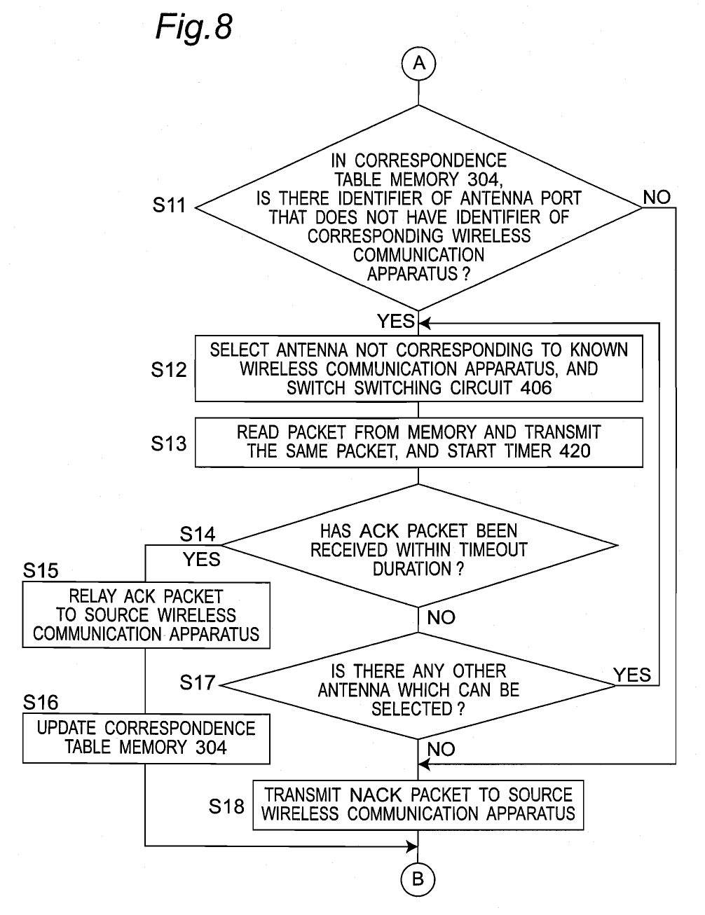

The update of the correspondence table memory 304 executed when relaying the data packets is described in detail below with reference to FIGS. 7 to 9. FIGS. 7 and 8 are flow charts showing a packet relaying process executed by the wireless repeater apparatus control circuit 404. In step S1 of FIG. 7, if the wireless repeater apparatus 302 receives a packet through any one of the receiving antennas 305, 307 and 310, then in step S2, the packet is stored to the corresponding memories 402, 410 and 416; or otherwise, the process flow repeats the step S1 to wait for a packet. Upon detecting by the memory control circuit 403, 411 or 416 that the packet has been stored to any one of the memories 402, 410 and 416, the wireless repeater apparatus control circuit 404 executes a source address extracting process in step S3.

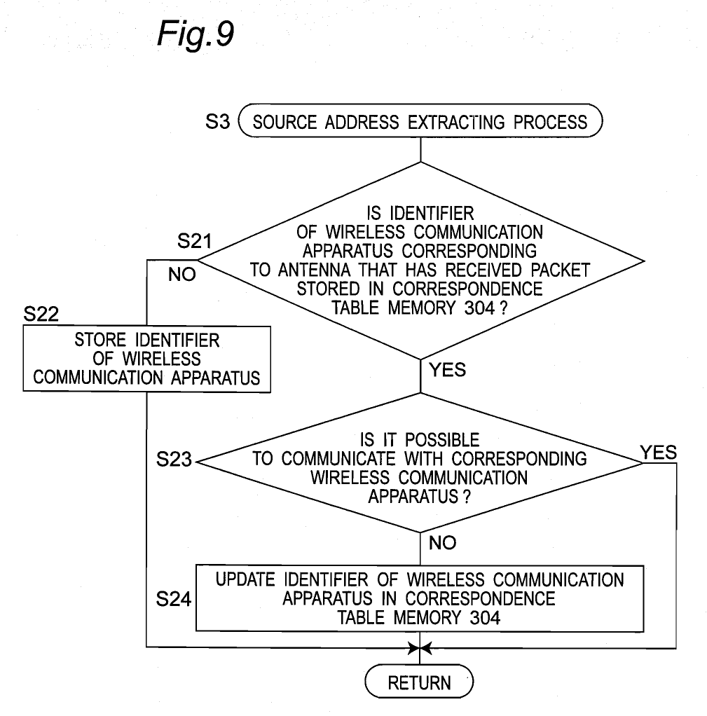

FIG. 9 is a flow chart showing the source address extracting process (step S3) that is a subroutine of FIG. 7. Step S3 is a process to update the contents of the correspondence table memory 304. In step S21 of FIG. 9, the wireless repeater apparatus control circuit 404 determines whether or not the identifier of the wireless communication apparatus corresponding to the identifier of the antenna port pertaining to the antenna that has received the packet (i.e., the receiving antenna corresponding to the memory in which the packet is stored) is stored in the correspondence table memory 304. If YES, the process flow proceeds to step S23 to determine whether or not the contents of the correspondence table memory 304 should be overwritten and updated; and if NO, the process flow proceeds to step S22. In step S22, the wireless repeater apparatus control circuit 404 extracts a source MAC address (i.e., the identifier of the source wireless communication apparatus) from the packet in the memory by the memory control circuit, and stores the extracted identifier to the correspondence table memory 304, and the process flow proceeds to step S4 of FIG. 7. In step S23, the wireless repeater apparatus control circuit 404 determines whether or not it is currently communicatable with the wireless communication apparatus specified by the identifier of the wireless communication apparatus found in the correspondence table memory 304 in step S21. In order to determine whether or not it is currently communicatable, the decision can be made by storing to a certain memory (not shown) an end time of communication with each wireless communication apparatus, and determining whether or not a certain time has passed since the end time of the preceding communication with the wireless communication apparatus in question. Alternatively, it is also possible to newly establish a communication for confirming whether or not it is currently communicatable with the wireless communication apparatus in question. If YES in step S23, the process flow proceeds to step S4 without updating the correspondence table memory 304; if NO, the process flow proceeds to step S24. In step S24, the wireless repeater apparatus control circuit 404 overwrites and updates the correspondence table memory 304, by deleting from the correspondence table memory 304 the identifier of the wireless communication apparatus determined to be uncommunicatable, then extracting the identifier of the source wireless communication apparatus from the packet in the memory, and storing the extracted identifier to the deleted portion in the correspondence table memory 304, and the process flow proceeds to step S4 of FIG. 7. As a modified preferred embodiment, when step S21 is NO, the process flow may proceed directly to step S4 without updating the correspondence table memory 304, instead of executing the steps S23 and S24.

In step S4 of FIG. 7, the wireless repeater apparatus control circuit 404 extracts a destination MAC address (i.e., the identifier of the destination wireless communication apparatus) from the packet in the memory by the memory control circuit, and the process flow proceeds to step S5. In step S5, the wireless repeater apparatus control circuit 404 determines whether or not the identifier of the destination wireless communication apparatus is stored in the correspondence table memory 304, if YES, the process flow proceeds to step S6; if NO, the process flow proceeds to step S11 of FIG. 8. In step S6, the wireless repeater apparatus control circuit 404 selects the antenna corresponding to the destination wireless communication apparatus, and makes the switching control circuit 405 switch the switching circuit 406 based on the selection result. Then, in step S7, the wireless repeater apparatus control circuit 404 reads the packet from the memory by the memory control circuit and transmits the same packet, and at the same time, starts counting in the timer circuit 420, and the process flow proceeds to step S8. In step S8, the wireless repeater apparatus control circuit 404 determines whether or not the ACK packet has been received from the destination wireless communication apparatus within the timeout duration, if YES, the process flow proceeds to step S9; if NO, the process flow proceeds to step S10. In step S9, the wireless repeater apparatus control circuit 404 relays the ACK packet to the source wireless communication apparatus, and the process flow returns to step S1. In step S10, the wireless repeater apparatus control circuit 404 updates the correspondence table memory 304 by deleting the identifier of the destination wireless communication apparatus of the packet from the correspondence table memory 304, so as to reflect the state that the wireless communication apparatus in question is uncommunicatable, and the process flow proceeds to step S11 of FIG. 8.

In the cases that step S5 or S8 of FIG. 7 is NO, if in the correspondence table memory 304, there is any identifier of the antenna port that does not have the identifier of the corresponding wireless communication apparatus, then it is tried to search for the antenna port communicatable with the destination wireless communication apparatus, by executing the steps S11 to S18 of FIG. 8. In step S11, the wireless repeater apparatus control circuit 404 determines whether or not in the correspondence table memory 304, there is any identifier of the antenna port that does not have the identifier of the corresponding wireless communication apparatus, if YES, the process flow proceeds to step S12; if NO, the process flow proceeds to step S18. In step S12, the wireless repeater apparatus control circuit 404 selects the transmitting antenna not corresponding to the known wireless communication apparatus (i.e., the transmitting antenna associated with the identifier of the antenna port that does not have the identifier of the corresponding wireless communication apparatus in the correspondence table memory 304) based on the correspondence table memory 304, makes the switching control circuit 405 switch the switching circuit 406 based on the selection result, then in step S13, reads the packet from the memory by the memory control circuit and retransmits the same packet, and at the same time, starts counting in the timer circuit 420, and the process flow proceeds to step S14. In step S14, the wireless repeater apparatus control circuit 404 determines whether or not the ACK packet has been received from the destination wireless communication apparatus within the timeout duration, if YES, the process flow proceeds to step S15; if NO, the process flow proceeds to step S17. In step 15, the wireless repeater apparatus control circuit 404 relays the ACK packet to the source wireless communication apparatus, and then in step 16, updates the correspondence table memory 304 so that the identifier of the antenna port pertaining to the antenna that has transmitted the packet in step S13 is correspondingly associated with the identifier of the destination wireless communication apparatus of the packet, and the process flow returns to step S1 of FIG. 7. In step S17, the wireless repeater apparatus control circuit 404 determines whether or not there is any other transmitting antennas which can be selected, and which is associated with the identifier of the antenna port that does not have the identifier of the corresponding wireless communication apparatus in the correspondence table memory 304, if YES, the process flow returns to step S12; if NO, the process flow proceeds to step S18. In step S18, the wireless repeater apparatus control circuit 404 transmits the NACK packet to the source wireless communication apparatus, and the process flow returns to step S1 of FIG. 7.

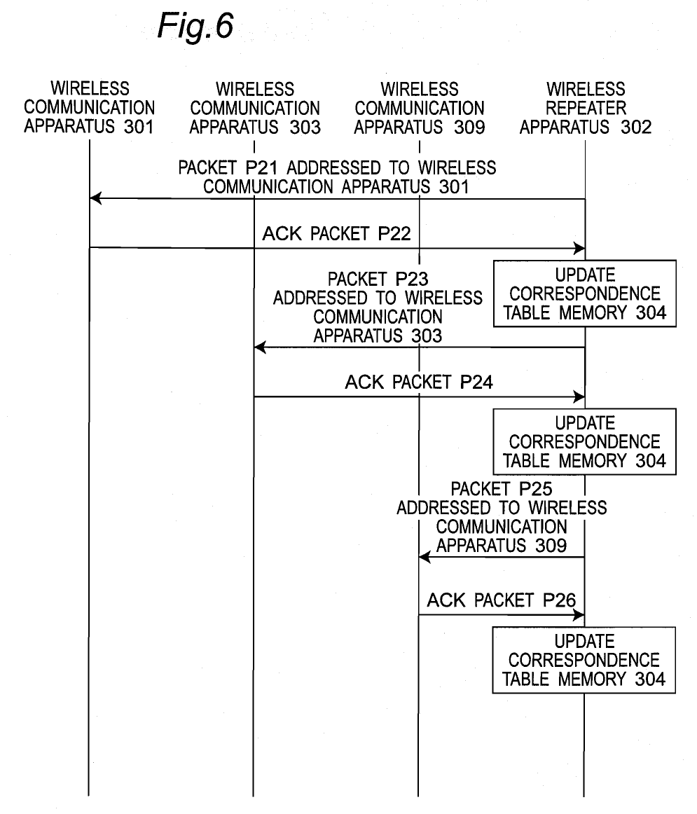

Next, another exemplary operation of the update of the correspondence table memory 304 is described with reference to FIG. 6. FIG. 6 is a sequence chart showing the exemplary operation of the correspondence table memory managing action executed in the wireless communication system of FIG. 3. The present exemplary operation is to transmit packets for the purpose of monitoring from the wireless repeater apparatus 302 to the wireless communication apparatuses 301, 303 and 309, and update the correspondence table memory 304 based on ACK packets received in response to them. The wireless repeater apparatus 302 transmits a packet P21 addressed to the wireless communication apparatus 301 through the transmitting antenna of selected one of the antenna ports, and in response to it, the wireless communication apparatus 301 returns an ACK packet P22 to the wireless repeater apparatus 302. The wireless repeater apparatus 302 receives the ACK packet P22 through the receiving antenna paired with the transmitting antenna, extracts the identifier M-A of the source wireless communication apparatus 301 from the received ACK packet P22, and stores the extracted identifier M-A to the correspondence table memory 304 as the identifier of the wireless communication apparatus corresponding to the identifier of the selected antenna port. Likewise, the wireless repeater apparatus 302 transmits a packet P23 addressed to the wireless communication apparatus 303 through the transmitting antenna of selected one of the antenna ports, and in response to it, the wireless communication apparatus 303 returns an ACK packet P24 to the wireless repeater apparatus 302. The wireless repeater apparatus 302 receives the ACK packet P24 through the receiving antenna paired with the transmitting antenna, extracts the identifier M-B of the source wireless communication apparatus 303 from the received ACK packet P24, and stores the extracted identifier M-B to the correspondence table memory 304 as the identifier of the wireless communication apparatus corresponding to the identifier of the selected antenna port. Likewise, the wireless repeater apparatus 302 transmits a packet P25 addressed to the wireless communication apparatus 309 through the transmitting antenna of selected one of the antenna ports, and in response to it, the wireless communication apparatus 309 returns an ACK packet P26 to the wireless repeater apparatus 302. The wireless repeater apparatus 302 receives the ACK packet P26 through the receiving antenna paired with the transmitting antenna, extracts the identifier M-C of the source wireless communication apparatus 309 from the received ACK packet P26, and stores the extracted identifier M-C to the correspondence table memory 304 as the identifier of the wireless communication apparatus corresponding to the identifier of the selected antenna port. If the ACK packets P22, P24 and P26 are not received, the wireless repeater apparatus 302 updates the correspondence table memory 304 so that the identifier of the wireless communication apparatus corresponding to the identifier of the selected antenna port becomes blank.

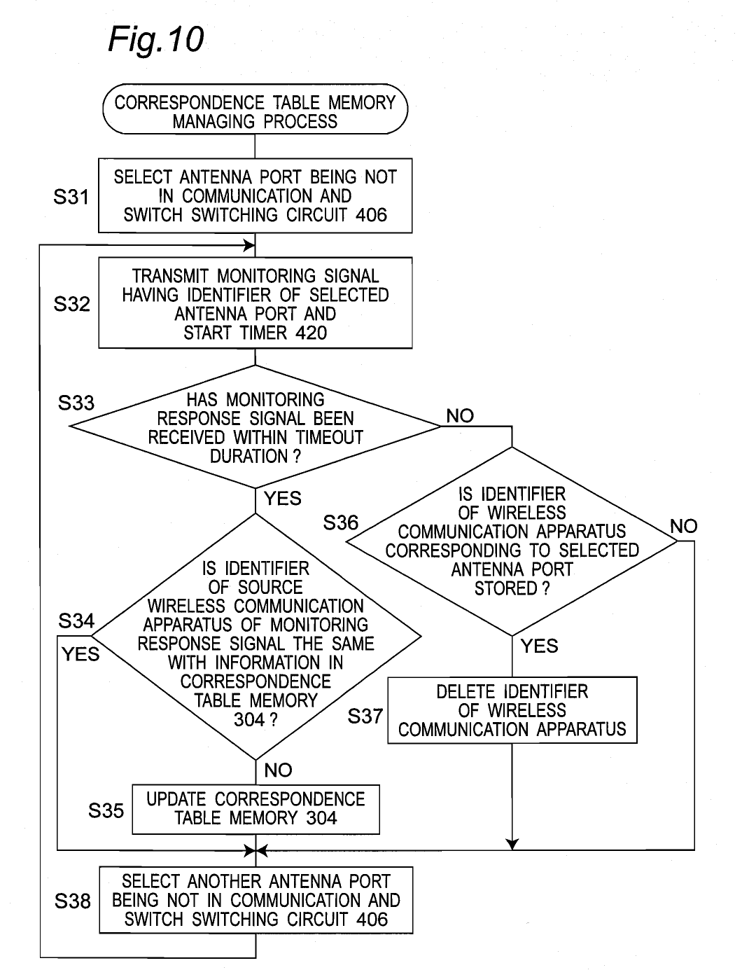

FIG. 10 is a flow chart showing the correspondence table memory managing process executed by the wireless repeater apparatus control circuit 404. In step S31 of FIG. 10, the wireless repeater apparatus control circuit 404 selects the antenna port that is not in communication, and makes the switching control circuit 405 switch the switching circuit 406. Then, in step S32, the wireless repeater apparatus control circuit 404 transmits a monitoring signal that has the identifier of the selected antenna port, and at the same time, starts counting in the timer circuit 420, and the process flow proceeds to step S33. In step S33, the wireless repeater apparatus control circuit 404 determines whether or not a monitoring response signal for the transmitted monitoring signal has been received within the timeout duration, if YES, the process flow proceeds to step S34; if NO, the process flow proceeds to step S36. In step S34, the wireless repeater apparatus control circuit 404 determines whether or not the identifier of the source wireless communication apparatus of the received monitoring response signal is the same with the information of the identifier of the wireless communication apparatus corresponding to the identifier of the selected antenna port in the correspondence table memory 304. If YES, the process flow proceeds directly to step S38; if NO (when different information is stored, or when no information is stored), the correspondence table memory 304 is updated in step S35, and the process flow proceeds to step S38. In step S36, the wireless repeater apparatus control circuit 404 determines whether or not the identifier of the wireless communication apparatus corresponding to the selected antenna port is stored in the correspondence table memory 304, if YES, the process flow proceeds to step S37 to delete the identifier of the wireless communication apparatus in question from the correspondence table memory 304, and proceeds to step S38; if NO, the process flow proceeds directly to step S38. In step S38, the wireless repeater apparatus control circuit 404 selects another antenna port that is not in communication, and makes the switching control circuit 405 switch the switching circuit 406, and the process flow returns to step S32.

The correspondence table memory managing process of FIG. 10 can be executed in order to, for example, confirm whether or not the correspondences between the identifier of the antenna port and the identifier of the wireless communication apparatus recorded in the correspondence table memory 304 are correct, or can be executed when in the correspondence table memory 304, there is the identifier of the antenna port that does not have the identifier of the corresponding wireless communication apparatus. The process may be executed when the communication of the data packet is not performed, when the communication of the data packet starts, when the communication of the data packet ends, every time a certain time duration passes, when a certain time has elapsed after the end of the communication of the data packet, etc.

Once the identifiers of the wireless communication apparatuses corresponding to the antenna port identifiers ANT-A, ANT-B, ANT-C are recorded in the correspondence table memory 304 by these processes, the memory control circuits 403, 411, 416 extract the identifier of the destination wireless communication apparatus from the data packets that have been respectively received through the receiving antennas 305, 307 and 310, processed upon reception by the receiver circuits 401, 409 and 414, and stored to the memories 402, 410 and 415, and send the identifier to the wireless repeater apparatus control circuit 404. The wireless repeater apparatus control circuit 404 looks up the correspondence table memory 304 based on the extracted identifier, and sends the identifier of the antenna port corresponding to the destination wireless communication apparatus to the switching control circuit 405. On the other hand, when the identifier of the destination wireless communication apparatus of the received data packet is not recorded in the correspondence table memory 304, or when the packet can not be relayed to the destination wireless communication apparatus when the steps S11 to S17 of FIG. 8 are executed, the wireless repeater apparatus control circuit 404 sends a signal indicating “no destination” to the switching control circuit 405, and the switching control circuit 405 controls the switching circuit 406 to select the transmitting antenna paired with the receiving antenna that has received the data packet. Then, the wireless repeater apparatus control circuit 404 transmits a communication response signal indicating the uncommunicatable status (NACK packet) through the selected transmitting antenna.

Therefore, for example, when executing the relaying process of the data packet received through the antenna 305, the memory control circuit 403 extracts the identifier of the destination wireless communication apparatus from the data packet that has been received through the receiving antenna 305 and processed for reception by the receiver circuit 401 and stored to the memory 402, and sends the identifier to the wireless repeater apparatus control circuit 404. The wireless repeater apparatus control circuit 404 looks up the correspondence table memory 304 based on the extracted identifier, and sends to the switching control circuit 405 the identifier of the antenna port corresponding to the destination wireless communication apparatus. Moreover, when the identifier of the destination wireless communication apparatus of the received data packet is not recorded in the correspondence table memory 304, or when the packet can not be relayed to the destination wireless communication apparatus when the steps S11 to S17 of FIG. 8 are executed, the wireless repeater apparatus control circuit 404 sends a signal indicating “no destination” to the switching control circuit 405, and the switching control circuit 405 controls the switching circuit 406 to select the transmitting antenna 306 paired with the receiving antenna 305. Then, the wireless repeater apparatus control circuit 404 transmits a communication response signal indicating the uncommunicatable status, by the switching circuit 406, the transmitter circuit 418 and the transmitting antenna 306. When executing the relaying process of the data packet received through the antenna 307 or 710, similar processing is performed.

Moreover, as described above, when the communication response signal for the data packet transmitted from the transmitting antenna of the certain antenna port is not received within the timeout duration, and the wireless repeater apparatus control circuit 404 deletes the identifier of the wireless communication apparatus corresponding to the identifier of the antenna port in the correspondence table memory 304, the wireless repeater apparatus control circuit 404 controls the switching control circuit 406 to turn off the power of the electric circuit connected to the transmitting antenna in question, in contemplation of the power saving of the wireless repeater apparatus 302. In this case, when it is detected that the receiving process has been performed by the receiver circuit connected to the receiving antenna of the antenna port, or when the identifier of the antenna port is sent from the wireless repeater apparatus control circuit 404 to the switching control circuit 405, the switching control circuit 405 controls the power of the electric circuit having been turned off to turn on again.

Therefore, for example, when the communication response signal for the data packet transmitted from the transmitting antenna 306 is not received within the timeout duration, and the wireless repeater apparatus control circuit 404 deletes the identifier of the wireless communication apparatus corresponding to the antenna port identifier ANT-A in the correspondence table memory 304, the wireless repeater apparatus control circuit 404 controls the switching control circuit 406 to turn off the power of the transmitter circuit 418 and the switches SW1, SW4, SW7 connected to the transmitting antenna 306. In this case, when it is detected that the receiving process has been performed by the receiver circuit 401 connected to the receiving antenna 305, or when the antenna port identifier ANT-A is sent from the wireless repeater apparatus control circuit 404 to the switching control circuit 405, the switching control circuit 405 controls the power of the transmitter circuit 418 and the switches SW1, SW4, SW7 connected to the transmitting antenna 306, to turn on. Similar processes are performed for saving the power of the electric circuits connected to the transmitting antenna 308 (transmitter circuit 408 and switches SW2, SW5, SW8), and the electric circuits connected to the transmitting antennas 311 (transmitter circuit 413 and switches SW3, SW6, SW9).

Moreover, when the wireless repeater apparatus control circuit 404 receives a plurality of requests for looking up the correspondence table memory 304 for the identifier of the destination wireless communication apparatus of the data packet from more than one of the memory control circuits 403, 411 and 416, the wireless repeater apparatus control circuit 404 may process these requests sequentially or in parallel. In the case of sequential processing, the wireless repeater apparatus control circuit 404 firstly looks up the correspondence table memory 304 for one request, sends to the switching control circuit 405 the identifier of the corresponding antenna port, or the signal indicating “no destination”, and thereafter looks up the correspondence table memory 304 for the next request. In the case of parallel processing, the wireless repeater apparatus control circuit 404 looks up the correspondence table memory 304 for one request, sends to the switching control circuit 405 the identifier of the corresponding antenna port, or the signal indicating “no destination”, and at the same time, looks up the correspondence table memory 304 for the next request.

### Modified Preferred Embodiment of First Preferred Embodiment

Although in the present preferred embodiment the wireless repeater apparatus 302 is constituted so as to look up the correspondence table memory 304 during communication, it is also possible to provide an auxiliary memory for the memory control circuits 403, 411, 416 or for the wireless repeater apparatus control circuit 404 and to store copies of the correspondences between the identifiers of the wireless communication apparatuses and the identifiers of the antenna ports stored in the correspondence table memory 304. In this case, it is also possible to adopt a configuration which firstly looks up the auxiliary memory to search for the antenna corresponding to the destination of the data packet when a data packet is received from a certain wireless communication apparatus, and then, looks up the correspondence table memory 304 in the case that no destination is recorded in the auxiliary memory.

Moreover, although the wireless communication apparatuses 301, 303 and 309 are assumed to communicate with the wireless repeater apparatus 302, one or two wireless communication apparatuses, or four or more wireless communication apparatuses may communicate with the wireless repeater apparatus 302.

Moreover, although the wireless repeater apparatus 302 has the two antennas. i.e., the receiving antenna 305 and the transmitting antenna 306, for communicating with the wireless communication apparatus 301, these antennas may be replaced by one antenna which can be used for both purpose of transmission and reception. Likewise, in order to communicate with the wireless communication apparatus 303, the receiving antenna 307 and the transmitting antenna 308 may be replaced by one antenna which can be used for both purpose of transmission and reception, and in order to communicate with the wireless communication apparatus 309, the receiving antenna 310 and the transmitting antenna 311 may be replaced by one antenna which can be used for both purpose of transmission and reception.

The antennas of the wireless communication apparatuses 301, 303, 309 and the antennas of the wireless repeater apparatus 302 may be external type antennas, or antennas of a type built in those apparatuses.

Moreover, although the wireless repeater apparatus control circuit 404 is configured to look up to the correspondence table memory 304 based on the identifier of the destination wireless communication apparatus extracted by the memory control circuit 403 and send the obtained antenna port identifier to the switching control circuit 405, it is also possible to send the identifier of the antenna port directly to the switching control circuit 405 without the wireless repeater apparatus control circuit 404.

Moreover, although the switching control circuit 405 is configure to control one switch SW in the switching circuit 406 to turn on based on the antenna port identifier, it is also possible to turn off all the switches SW1 to SW9 of the switching circuit 406 when any one of the transmitter circuits 418, 408, 413 completes the transmitting process. Alternatively, it is also possible to adopt a configuration in which only the switches SW1, SW4, SW7 connected to the transmitter circuit 418 are turned off when the transmitter circuit 418 completes the transmitting process, a configuration in which only the switches SW2, SW5, SW8 connected to the transmitter circuit 408 are turned off when the transmitter circuit 408 completes the transmitting process, or a configuration in which only the switches SW3, SW6, SW9 connected to the transmitter circuit 413 are turned off when the transmitter circuit 413 completes the transmitting process.

Moreover, although the receiver circuit 401 and the memory 402 have been separated from each other, the memory 402 and the receiver circuit 401 may be integrated together. Moreover, although the receiver circuit 409 and the memory 410 have been separated from each other, the memory 410 and the receiver circuit 409 may be integrated together. Moreover, although the receiver circuit 414 and the memory 415 have been separated from each other, the memory 415 and the receiver circuit 414 may be integrated together. Moreover, although the memory control circuits 403, 411, 416 have been separated from the wireless repeater apparatus control circuit 404, the memory control circuit 403 and/or 411 and/or 416 and the wireless repeater apparatus control circuit 404 may be integrated together. Moreover, although the timer circuit 420 and the wireless repeater apparatus control circuit 404 have been separated from each other, the timer circuit 420 and the wireless repeater apparatus control circuit 404 may be integrated together. Furthermore, the switching control circuit 405 may be constituted integrally with the wireless repeater apparatus control circuit 404.

Moreover, although the wireless repeater apparatus control circuit 404 is configured to delete the identifier of the wireless communication apparatus in question from the correspondence table memory 304 when the communication response signal for the transmitted data packet has not been received within the timeout duration, it is also possible that a component other than the wireless repeater apparatus control circuit 404 delete the identifier of the wireless communication apparatus in question from the correspondence table memory 304. Moreover, although the switching control circuit 405 is configured to control the power of the switching circuit 406 and the transmitter circuits 418, 408, 413 when the wireless repeater apparatus control circuit 404 has determined to be uncommunicatable as a consequence of failure of receiving the communication response signal for the transmitted data packet within the timeout duration, the power may be controlled by a component other than the switching control circuit 405. Moreover, although one wireless repeater apparatus control circuit 404 is configured to monitor whether the respective remote parties of communication corresponding to the transmitting antennas 306, 308, 311 is communicatable status or uncommunicatable, each of the transmitting antennas may be provided with a wireless repeater apparatus control circuit.

The timer circuit 420 may be reset and stopped, when the counting is stopped. In this case, the counting can be stopped, upon receiving the ACK packet for the packet transmitted when the counting has started, or upon the timeout duration expiring without receiving the ACK packet for the transmitted packet.

In the wireless communication system of the present preferred embodiment, an azimuth angle communicatable through each antenna port is narrowed when using as a wireless medium an electromagnetic wave such as a millimeter wave etc., that has a very straight propagation property, as described before. Therefore, the number of antenna ports to be provided for the wireless repeater apparatus 302 is not limited to three, and the wireless repeater apparatus 302 may be constituted so as to have, for example, eight or more antenna ports (i.e., eight or more pairs of transmitting antennas and receiving antennas).

### Second Preferred Embodiment

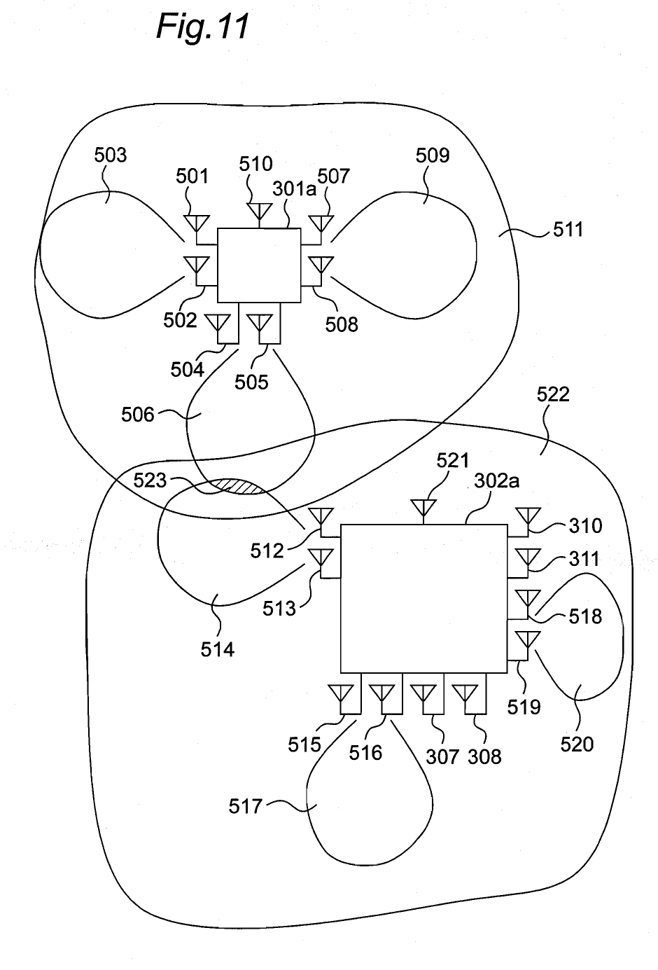

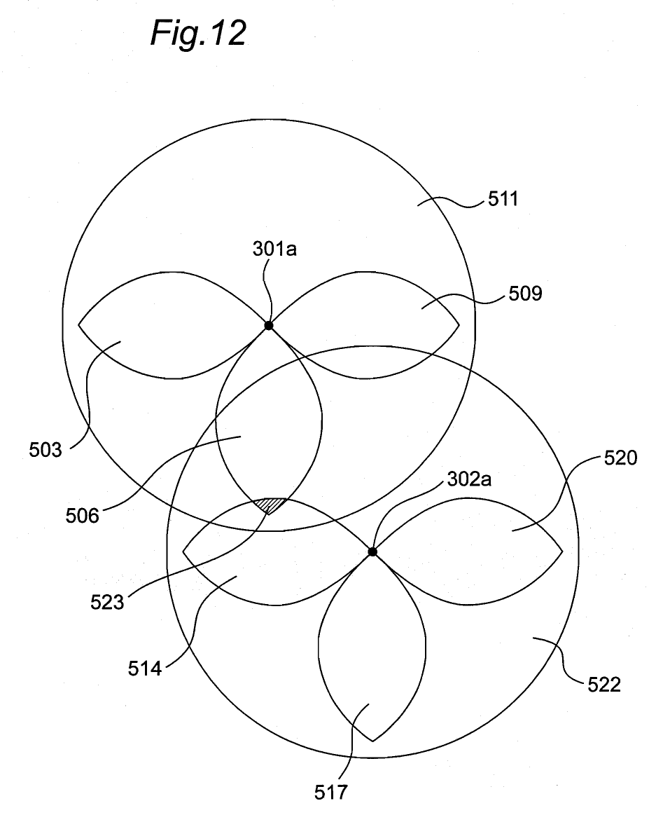

FIG. 11 is a block diagram of a wireless communication system of the second preferred embodiment of the present invention. In FIG. 11, the same components as those of FIG. 3 are denoted by the same reference numerals, and the descriptions are not repeated.

In FIG. 11, the wireless communication system of the present preferred embodiment is constituted of a wireless communication apparatus 301a and a wireless repeater apparatus 302a. The wireless communication apparatus 301a is provided with an antenna set including a plurality of antennas, particularly, including a plurality of receiving antennas 501, 504, 507 each having a certain directivity pattern and a plurality of transmitting antennas 502, 505, 508 each having a certain directivity pattern, as well as provided with an omni-directional transmitting and receiving antenna 510. Moreover, the wireless repeater apparatus 302a is provided with the receiving antennas 307, 310 and the transmitting antennas 308, 311 similar to those of the wireless repeater apparatus 302 of FIG. 3, and additionally, provided with an antenna set including a plurality of antennas, particularly, including a plurality of receiving antennas 512, 515, 518 each having a certain directivity pattern and a plurality of transmitting antennas 513, 516, 519 each having a certain directivity pattern, as well as provided with an omni-directional transmitting and receiving antenna 521.

The wireless communication apparatus 301a and the wireless repeater apparatus 302a communicate with each other as in the wireless communication apparatus 301 and the wireless repeater apparatus 302 of FIG. 3, and the wireless repeater apparatus 302a relays communications between the wireless communication apparatus 301a and other wireless communication apparatuses (not shown).

The wireless communication system of the present preferred embodiment is characterized in that the data packets are relayed as in the first preferred embodiment, and additionally, the wireless communication apparatus 301a uses antenna pairs: 501 and 502, 504 and 505, 507 and 508 in a switched manner in order to communicate with a particular wireless communication apparatus (not shown) or the wireless repeater apparatus 302a and the wireless repeater apparatus 302a uses antenna pairs: 512 and 513, 515 and 516, 518 and 519 in a switched manner in order to communicate with a particular wireless communication apparatus 301a or the like. In the first preferred embodiment, since each of the antenna ports of the wireless repeater apparatus 302 has been constituted to cover only a certain narrow range in azimuth, a number of antenna ports are required so that all the azimuth angles are covered, for the wireless repeater apparatus 302 to communicate with a wireless communication apparatus located at an arbitrary azimuth angle. On the other hand, according to the second preferred embodiment, a plurality of azimuth angle directions can be covered with the extended antenna ports provided with the plurality of antenna pairs: 512 and 513, 515 and 516, 518 and 519, in place of the antenna ports of the antennas 305, 306 of FIG. 3. With this arrangement, referring to, e.g., FIG. 11, the antenna pair 515, 516 and the antenna ports of the antennas 307, 308 are used, and thus, even when there are two wireless communication apparatuses in the direction of these antennas, it is possible to achieve simultaneous communications with those wireless communication apparatuses by using different wireless channels.

The antenna set including the plurality of antennas 512, 513, 515, 516, 518, 519 are assumed to be have the antenna port identifier ANT-A as in the antennas 305, 306 of FIG. 3.

In the wireless communication apparatus 301a, respective directivity patterns of the receiving antenna 501 and the transmitting antenna 502 are similar to each other and mutually overlaps in a coverage area 503, and therefore, the wireless communication apparatus 301a can communicate with other wireless communication apparatus (not shown) that has a coverage area of transmission and reception within the range of the coverage area 503. Moreover, respective directivity patterns of the receiving antenna 504 and the transmitting antenna 505 are similar to each other and mutually overlaps in a coverage area 506, and therefore, the wireless communication apparatus 301a can communicate with other wireless communication apparatus (in FIG. 11, wireless repeater apparatus 302a) that has a coverage area of transmission and reception within the range of the coverage area 506. Moreover, respective directivity patterns of the receiving antenna 507 and the transmitting antenna 508 are similar to each other and mutually overlaps in a coverage area 509, and therefore, the wireless communication apparatus 301a can communicate with other wireless communication apparatus (not shown) that has a coverage area of transmission and reception within the range of the coverage area 509. Moreover, the wireless communication apparatus 301a can communicate with other wireless communication apparatus (in FIG. 11, wireless repeater apparatus 302a) that has a coverage area of transmission and reception within a coverage area 511 of the omni-directional receiving antenna 510.

Furthermore, in the wireless repeater apparatus 302a, respective directivity patterns of the receiving antenna 512 and the transmitting antenna 513 are similar to each other and mutually overlaps in a coverage area 514, and therefore, the wireless repeater apparatus 302a can communicate with other wireless communication apparatus (in FIG. 11, wireless communication apparatus 301a) that has a coverage area of transmission and reception within the range of the coverage area 514. Moreover, respective directivity patterns of the receiving antenna 515 and the transmitting antenna 516 and the transmitting antenna 513 are similar to each other and mutually overlaps in a coverage area 517, and it is possible to communicate with other wireless communication apparatus (not shown) that has a coverage area of transmission and reception within the range of the coverage area 517. Moreover, respective directivity patterns of the receiving antenna 518 and the transmitting antenna 519 and the transmitting antenna 513 are similar to each other and mutually overlaps in a coverage area 520, and it is possible to communicate with other wireless communication apparatus (not shown) that has a coverage area of transmission and reception within the range of the coverage area 520. Moreover, the wireless repeater apparatus 302a can communicate with other wireless communication apparatus (in FIG. 11, wireless communication apparatus 301a) that has a coverage area of transmission and reception within a coverage area 522 of the omni-directional receiving antenna 521.

FIG. 12 is a plan view showing in detail the coverage areas of the wireless communication system of FIG. 11. The wireless communication apparatus 301a and the wireless repeater apparatus 302a use as a wireless medium an electromagnetic wave such as a millimeter wave etc., that has a very straight propagation property, and therefore, each of the coverage areas 503, 506, 509, 514, 517, 520 has a shape of beam with a narrow angular width. Although it is preferred that the beam-shaped coverage areas do not overlap one another and are each provided to cover an arbitrary azimuth angle in a horizontal plane in each of the wireless communication apparatus 301a and the wireless repeater apparatus 302a, only three areas are provided for each of the apparatuses in FIG. 11 for the sake of simplicity of illustration.

The wireless communication apparatus 301a and the wireless repeater apparatus 302a have an overlap between the coverage area 506 and the coverage area 514 (i.e., a coverage area 523). Therefore, communication between the wireless communication apparatus 301a and the wireless repeater apparatus 302a can be achieved by using the receiving antenna 504 and the transmitting antenna 505 of the wireless communication apparatus 301a, and the receiving antenna 512 and the transmitting antenna 513 of the wireless repeater apparatus 302a.

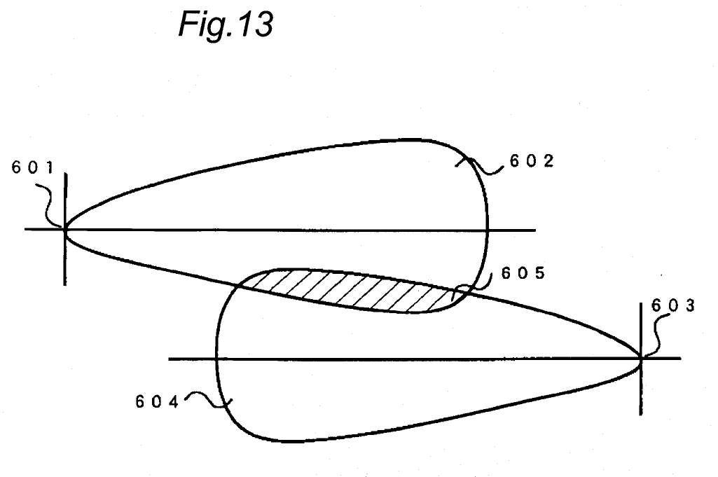

FIG. 13 is a pattern map for explaining the antenna directivity in the wireless communication system of FIG. 11. In FIG. 13, it is assumed that when a wireless communication apparatus having a directional antenna is installed in an installation position 601 and a wireless communication apparatus having a directional antenna is installed in an installation position 603, the directional antenna in the installation position 601 has a coverage area 602 and the directional antenna in the installation position 603 has a coverage area 604. In this case, if there is an overlapping coverage area 605 between the coverage area 602 and the coverage area 604, it is possible to communicate between the wireless communication apparatuses installed in the installation positions 601 and 603. On the other hand, if there is no such overlap, the communication is difficult.

According to the above configuration, the wireless communication apparatus 301a can communicate with other wireless communication apparatus (not shown) that has a coverage area of transmission and reception within the range of the coverage area 503, by providing the receiving antenna 501 and the transmitting antenna 502 for the wireless communication apparatus 301a so that the coverage areas of the directivity patterns mutually overlap in the coverage area 503. As described above, the receiving antenna 501 and the transmitting antenna 502 are paired with each other. Likewise, the receiving antenna 504 and the transmitting antenna 505 are paired with each other, and the receiving antenna 507 and the transmitting antenna 508 are paired with each other. Moreover, one of the purposes for providing the wireless communication apparatus 301a with the plurality of transmitting antennas and the plurality of receiving antennas is to enable communication with other wireless communication apparatus (not shown) installed in an arbitrary direction with respect to the wireless communication apparatus 301a even when using directional antennas. Therefore, the range communicatable by the wireless communication apparatus 301a is a coverage area corresponding to a sum of the coverage areas 503, 506 and 509. For example, if there is an overlap between the coverage areas 503 and 506, or between the coverage areas 503 and 509, or between the coverage areas 506 and 509, the range communicatable by the wireless communication apparatus 301a is reduced, and accordingly, it is desirable to provide the wireless communication apparatus 301a with the respective antennas so as to avoid an overlap between these coverage areas as small as possible. The same thing can be applied when providing the wireless repeater apparatus 302a with the antennas.

When starting communication between the wireless communication apparatus 301a and the wireless repeater apparatus 302a, it is necessary to select one pair of antennas from the plurality of transmitting antennas 502, 505, 508 and the plurality of receiving antennas 501, 504, 507 provided for the wireless communication apparatus 301a, and to select one pair of antennas from the plurality of transmitting antennas 513, 516, 519 and the plurality of receiving antennas 512, 515, 518 provided for the wireless repeater apparatus 302a. It is noted that since the antenna 521 of the wireless repeater apparatus 302a and the antenna 510 of the wireless communication apparatus 301a are both omni-directional, and the coverage area 522 of the antenna 521 and the coverage area 511 of the antenna 510 mutually overlap, the wireless communication apparatus 301a and the wireless repeater apparatus 302a can communicate with each other by using these antennas 510, 521. The wireless communication apparatus 301a selects one from the plurality of transmitting antennas 502, 505 and 508, and transmits a data packet to the wireless repeater apparatus 302a. The wireless repeater apparatus 302a selects one from the plurality of receiving antennas 512, 515 and 518, and receives the data packet, or otherwise, if no data packet can be received through the selected receiving antenna, switches to the other antenna and receives the data packet. If all the receiving antennas 512, 515, 518 fail to receive, the wireless repeater apparatus 302a transmits a feedback signal to the antenna 510 through the antenna 521, that indicates the result of an “uncommunicatable status”. Upon receiving through the antenna 510 the feedback signal indicating the “uncommunicatable status”, the wireless communication apparatus 301a selects another transmitting antenna among the transmitting antennas 502, 505 and 508, and transmits a data packet to the wireless repeater apparatus 302a. By repeating these processes, a combination of one of the transmitting antennas 502, 505, 508 of the wireless communication apparatus 301a and one of the receiving antennas 512, 515, 518 of the wireless repeater apparatus 302a is selected such that the data packet transmitted from the wireless communication apparatus 301a can be received by the wireless repeater apparatus 302a.

When one transmitting antenna is selected in the wireless communication apparatus 301a, the wireless communication apparatus 301a selects the receiving antenna to be paired with it. Likewise, when one receiving antenna of the wireless repeater apparatus 302a is selected, the wireless repeater apparatus 302a selects the transmitting antenna to be paired with it. Thus, the transmitting antenna and the receiving antenna that the wireless communication apparatus 301a uses for the communication with the wireless repeater apparatus 302a are selected, and the transmitting antenna and the receiving antenna that the wireless repeater apparatus 302a uses for the communication with the wireless communication apparatus 301a are selected.

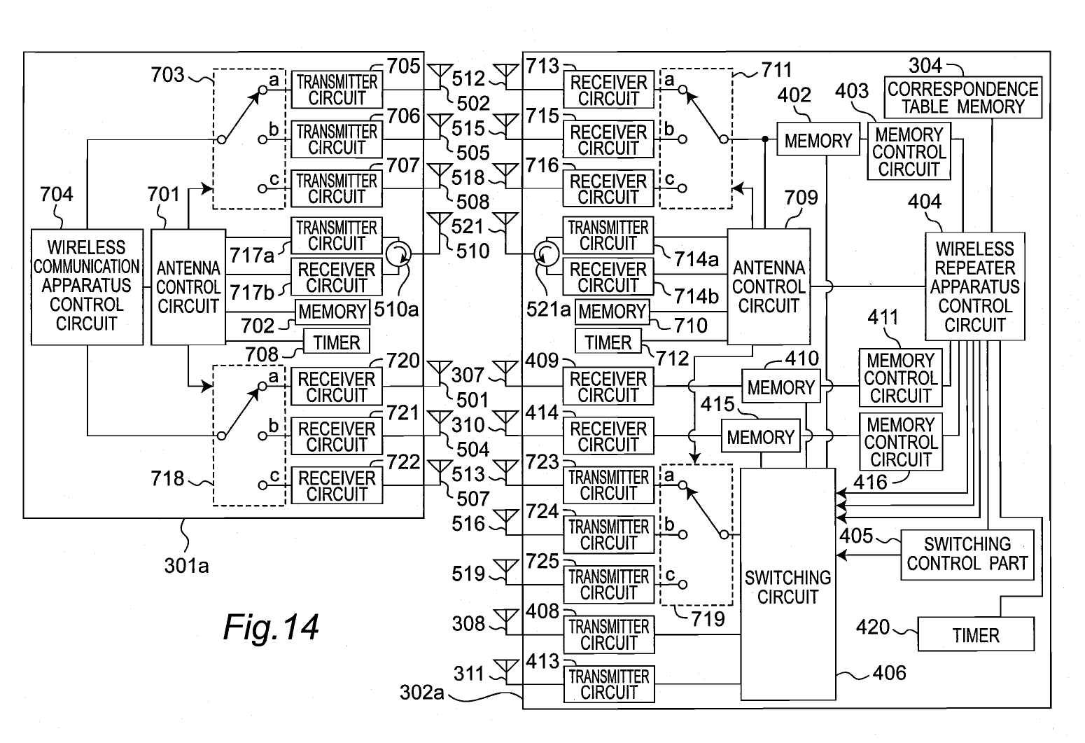

FIG. 14 is a block diagram showing the detailed configuration of the wireless communication apparatus 301a and the wireless repeater apparatus 302a of FIG. 11. In FIG. 14, the same components as those of FIGS. 3, 4 and 11 are denoted by the same reference numerals, and the descriptions are not repeated.

In FIG. 14, the wireless communication apparatus 301a has a wireless communication apparatus control circuit 704 that manages the signals to be transmitted and received and that controls the operation of the wireless communication apparatus 301a, and an output signal from the wireless communication apparatus control circuit 704 is inputted to the antenna control circuit 701, and to a switch 703 for transmission use. The switch 703 has one input terminal and three output terminals “a”, “b”, “c”, and the terminals “a”, “b”, “c” are connected to the transmitting antennas 502, 505, 508 via the wireless transmitter circuits (hereinafter referred to as transmitter circuits) 705, 706, 707, respectively. The switch 703 selectively switches to connect the input terminal to any one of the output terminals “a”, “b”, “c” in response to a control signal from the antenna control circuit 701, for transmitting an output signal from the wireless communication apparatus control circuit 704. Moreover, the receiving antennas 501, 504, 507 are connected to the wireless receiver circuits (hereinafter referred to as receiver circuits) 720, 721, 722, respectively, and the receiver circuits 720, 721, 722 are connected on the output side to the input terminals “a”, “b”, “c”, respectively, of the switch 718 for reception use. The switch 718 selectively switches to connect any one of the input terminals “a”, “b”, “c” to the output terminal in response to the control signal from the antenna control circuit 701, for transmitting the received signal to the wireless communication apparatus control circuit 704. Further, the antenna 510 is connected to a feedback transmitter circuit 717a and a feedback receiver circuit 717b through a circulator 510a. The feedback transmitter circuit 717a is further connected to the antenna control circuit 701, while the feedback transmitter circuit 717a, the circulator 510a and the antenna 510 cooperate as means for feedback transmission to the wireless repeater apparatus 302a (described in detail later). The feedback receiver circuit 717b is further connected to the antenna control circuit 701, while the antenna 510, the circulator 510a and the feedback receiver circuit 717b cooperate as means for feedback reception from the wireless repeater apparatus 302a (described in detail later). A memory 702 and a timer circuit 708 are further connected to the antenna control circuit 701.

Moreover, the wireless repeater apparatus 302a has receiving antennas 512, 515 and 518, receiver circuits 713, 715 and 716, and a switch 711 for reception, in place of the receiving antenna 305 and the receiver circuit 401 of FIG. 4. The receiving antennas 512, 515, 518 are connected to the receiver circuits 713, 715, 716, respectively, and the receiver circuits 713, 715, 716 are connected on the output side to the input terminals “a”, “b”, “c”, respectively, of the switch 711. The wireless repeater apparatus 302a further includes an antenna control circuit 709 that operates under the control of the wireless repeater apparatus control circuit 404. The switch 711 selectively switches to connect any one of the input terminals “a”, “b”, “c” to the output terminal in response to the control signal from the antenna control circuit 701 connected to the output terminal, for temporarily storing the received signal to the memory 402. Moreover, the wireless repeater apparatus 302a has the transmitting antennas 513, 516 and 519, transmitter circuits 723, 724 and 725, and a switch 719 for transmission, in place of the transmitting antenna 306 and the transmitter circuit 418 of FIG. 4, and one of output signals from the switching circuit 406 is inputted to the switch 719, not to the transmitter circuit 418. The switch 719 has one input terminal and three output terminals “a”, “b”, “c”, and the terminals “a”, “b”, “c” are connected to the transmitting antennas 513, 516, 519 through the transmitter circuits 723, 724, 725, respectively. The switch 719 selectively switches to connect the input terminal to any one of the output terminals “a”, “b”, “c” in response to a control signal from the antenna control circuit 709, for transmitting an output signal from the switching circuit. Further, a feedback transmitter circuit 714a and a feedback receiver circuit 714b are further connected to the antenna control circuit 709. The feedback transmitter circuit 714a is further connected to the antenna 521 through a circulator 521a, while the feedback transmitter circuit 714a, the circulator 521a and the antenna 521 cooperate as means for feedback transmission to the wireless communication apparatus 301a (described in detail later). The feedback receiver circuit 714b is further connected to the antenna 521 through the circulator 521a, while the antenna 521, the circulator 521a and the feedback receiver circuit 714b cooperate as means for feedback reception from the wireless communication apparatus 301a (described in detail later). A memory 710 and a timer circuit 712 are further connected to the antenna control circuit 709.

Now, a procedure is described for determining one transmitting antenna among the transmitting antennas 502, 505, 508 in the wireless communication apparatus 301a and determining one receiving antenna among the receiving antennas 512, 515, 518 in the wireless repeater apparatus 302a, when a communication is performed between the wireless communication apparatus 301a and the wireless repeater apparatus 302a.

The memory 702 of the wireless communication apparatus 301a stores transmitting antenna information pertaining to the transmitting antennas 502, 505 and 508, and/or receiving antenna information pertaining to the receiving antennas 501, 504 and 507, used for communicating with the wireless repeater apparatus 302a at the time of the previous communication (or before the previous power off of the wireless communication apparatus 301a). If no communication has previously been performed with the wireless repeater apparatus 302a, the memory 702 stores a certain initial value. When the power of the wireless communication apparatus 301a is turned on or when the wireless communication apparatus 301a detects the disconnection of communication with the wireless repeater apparatus 302a, the antenna control circuit 701 of the wireless communication apparatus 301a reads from the memory 702 the transmitting antenna information pertaining to the transmitting antenna used for communicating with the wireless repeater apparatus 302a at the time of previously turning on the power; or alternatively, if no communication has been performed with the wireless repeater apparatus 302a at the time of previously turning on the power, the antenna control circuit 701 reads the initial value from the memory 702; and then the antenna control circuit 701 controls the switch 703 to select any one of the transmitting antennas 502, 505, 508. For example, when the transmitting antenna 502 is selected, the transmitter circuit 705 transmits through the transmitting antenna 502 a data packet having the identifier of the wireless communication apparatus 301a as the source address and having the identifier of the wireless repeater apparatus 302a as the destination address, according to a part of the transmitting process inherent to the transmitter circuit 705, or according to control by the wireless communication apparatus control circuit 704 that controls the wireless communication apparatus 301a. Likewise, when the transmitting antenna 505 or 508 is selected, a data packet is also transmitted by the corresponding transmitter circuit 706 or 707. Upon transmitting the data packet from the transmitting antenna 502, 505 or 510, at the same time, the antenna control circuit 701 starts counting in the timer circuit 708.

On the other hand, the memory 710 of the wireless repeater apparatus 302a stores receiving antenna information pertaining to the receiving antennas 512, 515 and 518, and/or transmitting antenna information pertaining to the transmitting antennas 513, 516 and 519, used for communicating with the wireless communication apparatus 301a at the time of the previous communication (or the previous power off of the wireless repeater apparatus 302a). If no communication has previously been performed with the wireless communication apparatus 301a, the memory 710 stores a certain initial value. When the power of the wireless repeater apparatus 302a is turned on or when the wireless repeater apparatus 302a detects the disconnection of communication with the wireless communication apparatus 301a, the antenna control circuit 709 of the wireless repeater apparatus 302a reads from the memory 710 the receiving antenna information used for communicating with the wireless communication apparatus 301a at the time of previously turning on the power; or otherwise, if no communication has been performed with the wireless communication apparatus 301a at the time of previously turning on the power, the antenna control circuit 709 reads the initial value from the memory 710; and then the antenna control circuit 709 controls the switch 711 to select any one of the receiving antennas 512, 515, 518. For example, when the receiving antenna 512 is selected, the antenna control circuit 709 turns the switch 711 to the contact “a”, and at the same time, starts counting in the timer circuit 712. When the data packet is received within the timeout duration, the received data packet is subjected to a receiving process in the receiver circuit, and the processed data packet is temporarily stored to the memory 402. The memory control circuit 403 extracts a destination address from the data packet temporarily stored in the memory 402, and the extracted address is sent to the antenna control circuit 709 through the wireless repeater apparatus control circuit 404. If the extracted destination address is the address of the wireless repeater apparatus 302a, this implies that it is possible to communicate with the source wireless communication apparatus 301a of the data packet, the antenna control circuit 709 transmits a feedback signal from the feedback transmitter circuit 714a to the wireless communication apparatus 301a indicating a communicatable status, and writes into the memory 710 the identifier of the receiving antenna 512 being in the communicatable status.

On the other hand, when no data packet can be received through the receiving antenna 512 until the timeout duration elapses (i.e., until the count of the timer circuit 712 reaches or exceeds a certain value) or when the destination address of the received data packet is not the address of the wireless repeater apparatus 302a, the antenna control circuit 709 controls the switch 711 to select the next receiving antenna 515, resets and restarts the count of the timer circuit 712, continues the reception through the receiving antenna 515 until the timeout duration elapses, and waits to receive the data packet that has the address of the wireless repeater apparatus 302a as the destination address. When no data packet can be received through the receiving antenna 515 until the timeout duration elapses or when the destination address of the data packet received through the receiving antenna 515 is not the address of the wireless repeater apparatus 302a, the antenna control circuit 709 waits to receive the data packet by the similar process using the receiving antenna 518 and the receiver circuit 716. Furthermore, when no data packet can be received through the receiving antenna 518 until the timeout duration elapses or when the destination address of the data packet received through the receiving antenna 518 is not the address of the wireless repeater apparatus 302a, in other words, when the reception can not be achieved by any of the receiving antennas selectable by the switch 711, the antenna control circuit 709 transmits a feedback signal indicating an “uncommunicatable status”, by the feedback transmitter circuit 714a, to the wireless communication apparatus 301a.

When the feedback signal indicating the “communicatable status” is received before the timeout duration elapses (i.e., before the count of the timer circuit 708 reaches or exceeds a certain value), the feedback receiver circuit 717b of the wireless communication apparatus 301a writes into the memory 702 the transmitting antenna information in use. Otherwise, when any signal is not received until the timeout duration elapses or when the feedback signal indicating the uncommunicatable status is received regardless of the count of the timer circuit 708, the antenna control circuit 701 controls the switch 703 to select other transmitting antenna in a similar manner as the switching of the receiving antenna by the antenna control circuit 709 of the wireless repeater apparatus 302a.

When the transmitting antenna of the wireless communication apparatus 301a and the receiving antenna of the wireless repeater apparatus 302a are selected by the above process, the antenna control circuit 701 of the wireless communication apparatus 301a controls the switch 718 to select the receiving antenna paired with the transmitting antenna, and the antenna control circuit 709 of the wireless repeater apparatus 302a controls the switch 719 to select the transmitting antenna paired with the receiving antenna. In this case, when the receiving antenna 501 of the wireless communication apparatus 301a is selected, the wireless communication apparatus 301a performs the receiving process by the receiver circuit 720; or alternatively, when the receiving antenna 504 is selected, the wireless communication apparatus 301a performs the receiving process by the receiver circuit 721; or when the receiving antenna 507 is selected the wireless communication apparatus 301a performs the receiving process by the receiver circuit 722. Moreover, when the transmitting antenna 513 of the wireless repeater apparatus 302a is selected, the wireless repeater apparatus 302a performs the transmitting process by the transmitter circuit 723; or alternatively, when the transmitting antenna 516 is selected, the wireless repeater apparatus 302a performs the transmitting process by the transmitter circuit 724, or when the transmitting antenna 519 is selected, the wireless repeater apparatus 302a performs the transmitting process by the transmitter circuit 725.

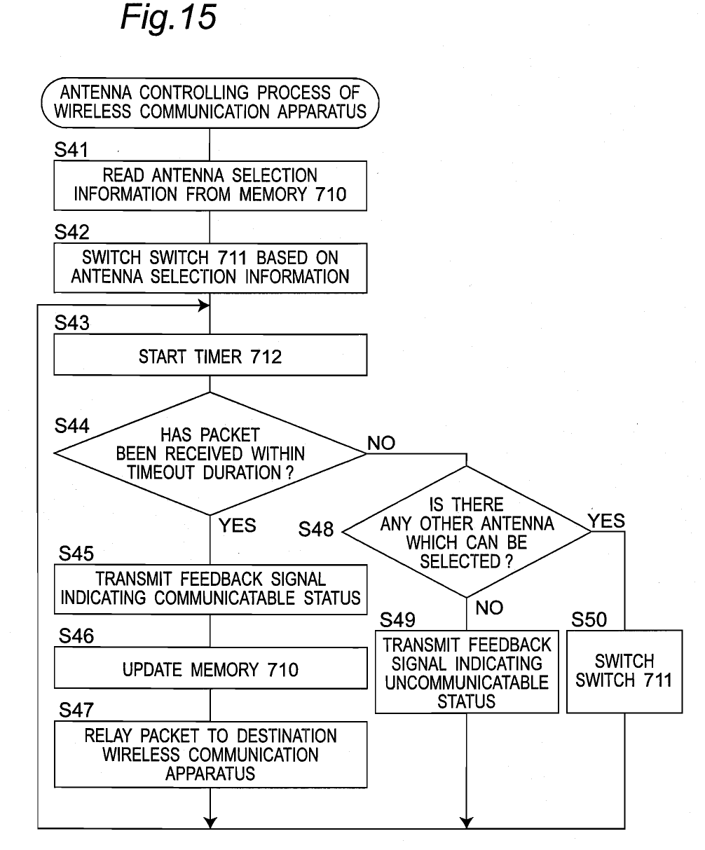

Now, the aforementioned antenna controlling operations of the wireless communication apparatus 301a and the wireless repeater apparatus 302a is described in detail with reference to the flow charts of FIGS. 15 to 20.

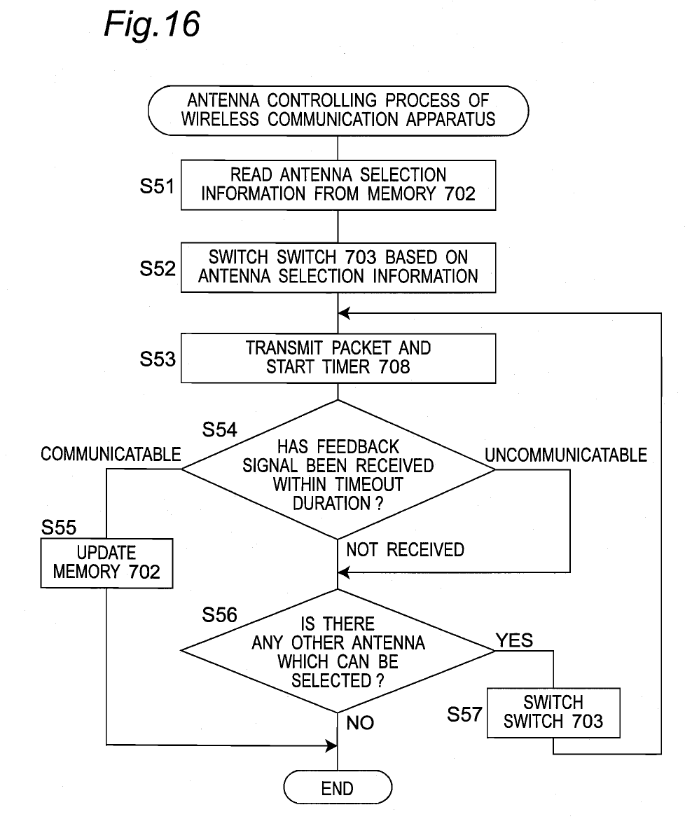

FIG. 15 is a flow chart showing the antenna controlling process executed by the antenna control circuit 709 of the wireless repeater apparatus 302a, and FIG. 16 is a flow chart showing the antenna controlling process executed by the antenna control circuit 701 of the wireless communication apparatus 301a. The processes of FIGS. 15 and 16 are executed during a process in which the wireless repeater apparatus 302a relays packet transmission from the wireless communication apparatus 301a to another wireless communication apparatus (not shown), and characterized in that the wireless communication apparatus 301a determines one transmitting antenna to be used among the transmitting antennas 502, 505, 508, and the wireless repeater apparatus 302a determines one receiving antenna to be used among the receiving antennas 512, 515, 518.

In step S41 of FIG. 15, the antenna control circuit 709 of the wireless repeater apparatus 302a reads from the memory 710 the past or initial value of the antenna selection information, and in step S42, turns the switch 711 so as to select any one of the receiving antennas 512, 515, 518 based on the antenna selection information, and in step S43, at the same time with the switching, starts counting in the timer circuit 712. Next, in step S44, the antenna control circuit 709 determines whether or not the packet to be relayed has been received within the timeout duration; and if YES, the process flow proceeds to step S45; if NO, the process flow proceeds to step S48. In the case that the packet to be relayed is received, the packet is temporarily stored to the memory 402 as in the first preferred embodiment. In step S45, the antenna control circuit 709 transmits the feedback signal indicating the “communicatable status” through the transmitter circuit 714a and the antenna 521 to the wireless communication apparatus 301a, and in step S46, updates the antenna selection information in the memory 710 based on the state of the switch 711 when the packet is received. Subsequently, in step S47, the antenna control circuit 709 passes the control to the wireless repeater apparatus control circuit 404 for relaying the received packet to the destination wireless communication apparatus. The packet relaying process can be executed as in the first preferred embodiment, and for example, it is possible to execute a process of subroutine including the steps S2 to S18 of the processes of FIGS. 7 and 8, and being configured to end without returning to the step S1 after the execution of the steps S9, S16 and S18. After executing the step S47, the process flow returns to step S43. Moreover, in step S48, the antenna control circuit 709 determines whether or not there is any other antenna which can be selected; and if YES, the process flow proceeds to step S50; or if NO, the process flow proceeds to step S49. In step S50, the antenna control circuit 709 changes the switch 711, and the process flow returns to step S43. In step S49, the antenna control circuit 709 transmits the feedback signal indicating the “uncommunicatable status” through the transmitter circuit 714a and the antenna 521 to the wireless communication apparatus 301a, and the process flow returns to step S43.

In step S51 of FIG. 16, the antenna control circuit 701 of the wireless communication apparatus 301a reads from the memory 702 the past or initial value of the antenna selection information, and in step S52, turns the switch 703 to select any one of the transmitting antennas 502, 505, 508 based on the antenna selection information. Next, in step S53, the antenna control circuit 701 transmits the packet through the selected antenna, and at the same time, starts counting in the timer circuit 708, and the process flow proceeds to step S54. In step S54, the antenna control circuit 701 determines whether or not the feedback signal has been received through the antenna 510 and the receiver circuit 717b within the timeout duration, and if the feedback signal indicating the “communicatable status” has been received, the process flow proceeds to step S55; if the feedback signal indicating the “uncommunicatable status” has been received or if no feedback signal has been received, the process flow proceeds to step S56. In step S55, the antenna control circuit 701 updates the antenna selection information in the memory 710 based on the state of the switch 703 when the packet has been transmitted in step S53, and ends the process. In step S56, the antenna control circuit 701 determines whether or not there is any other antenna which can be selected; and if YES, turns the switch 703 in step S57 and returns to step S53; if NO, ends the process.

According to the processes of FIGS. 15 and 16, at the same time, while the wireless repeater apparatus 302a relays the packet from the wireless communication apparatus 301a to another wireless communication apparatus (not shown), the wireless communication apparatus 301a can determine one transmitting antenna available for communication among the transmitting antennas 502, 505 and 508, and the wireless repeater apparatus 302a can determine one receiving antenna available for communication among the receiving antennas 512, 515 and 518.

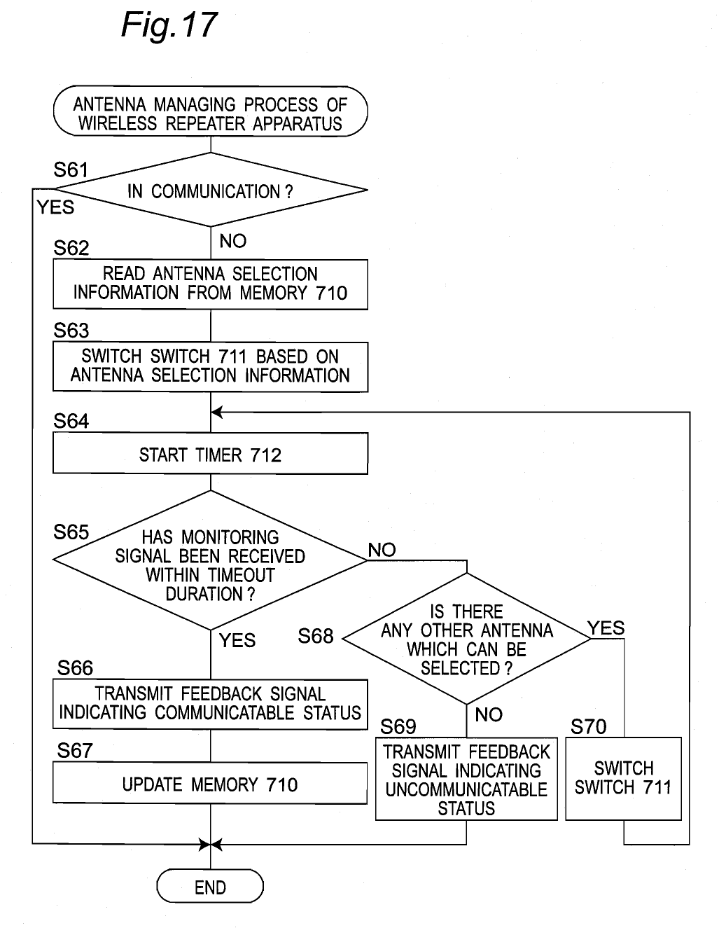

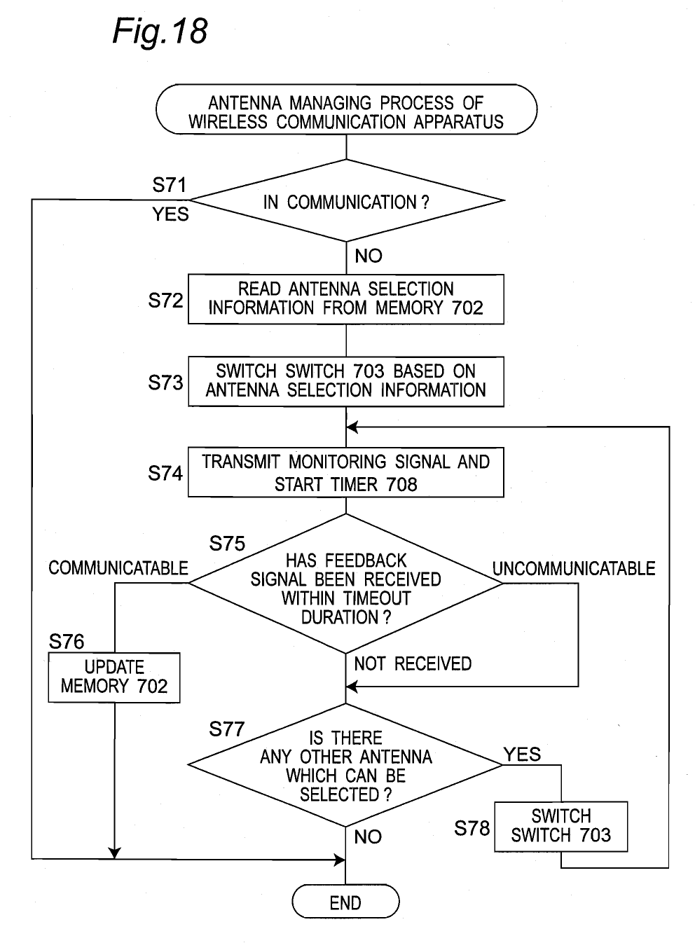

It is also possible to determine the antenna to be used during an idle state in which no packet is relayed. FIG. 17 is a flow chart showing the antenna managing process executed by the antenna control circuit 709 of the wireless repeater apparatus 302a, and FIG. 18 is a flow chart showing the antenna managing process executed by the antenna control circuit 701 of the wireless communication apparatus 301a. The processes of FIGS. 17 and 18 are executed when there is no communication for packet relaying, and characterized in that the wireless communication apparatus 301a determines one transmitting antenna to be used among the transmitting antennas 502, 505 and 508, and the wireless repeater apparatus 302a determines one receiving antenna to be used among the receiving antennas 512, 515 and 518.

In step S61 of FIG. 17, the antenna control circuit 709 of the wireless repeater apparatus 302a determines whether or not the wireless repeater apparatus 302a is in communication, and if YES, the process flow immediately ends; if NO, the process flow proceeds to step S62. The steps S62 to S64 are the same as the steps S41 to S43 of FIG. 15, respectively. Next, in step S65, the antenna control circuit 709 determines whether or not a monitoring signal has been received from the wireless communication apparatus 301a within the timeout duration, the monitoring signal is for examining whether or not the transmitting antenna selected in the wireless communication apparatus 301a can be used for communication. If YES, the process flow proceeds to step S66; if NO, proceeds to step S68. The step S66 and the subsequent step S67 are the same as the steps S45 and S46 of FIG. 15, and after executing step S66, the process flow ends. Moreover, the steps S68 to S70 are the same as the steps S48 to S50 of FIG. 15, respectively. After executing step S69, the process flow immediately ends. After executing step S70, the process flow returns to step S64.

In step S71 of FIG. 18, the antenna control circuit 701 of the wireless communication apparatus 301a determines whether or not the wireless communication apparatus 301a is in communication, and if YES, the process flow immediately ends; if NO, the process flow proceeds to step S72. The steps S72 and S73 are the same as the steps S51 and S52 of FIG. 16, respectively. Next, in step S53, the antenna control circuit 701 transmits a monitoring signal from the transmitting antenna selected in step S73, for examining whether or not the transmitting antenna in question can be used for communication, and at the same time, starts counting in the timer circuit 708. The subsequent steps S75 to S78 are the same as the steps S54 to S57 of FIG. 16, respectively.

According to the processes of FIGS. 17 and 18, when there is no communication for the packet relaying, the wireless communication apparatus 301a can determine one transmitting antenna available for communication among the transmitting antennas 502, 505 and 508, and the wireless repeater apparatus 302a can determine one receiving antenna available for communication among the receiving antennas 512, 515 and 518.

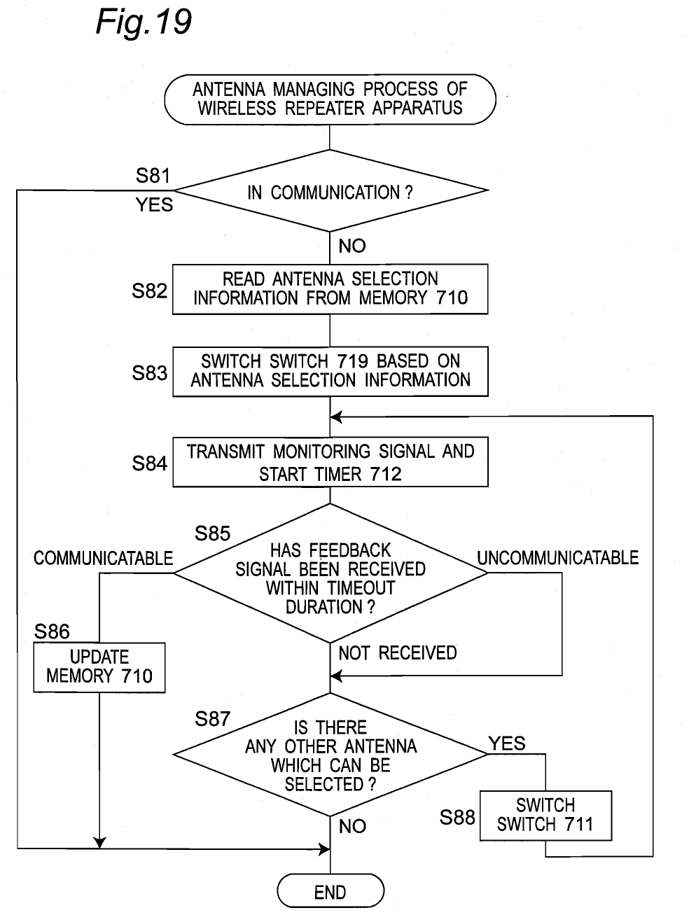

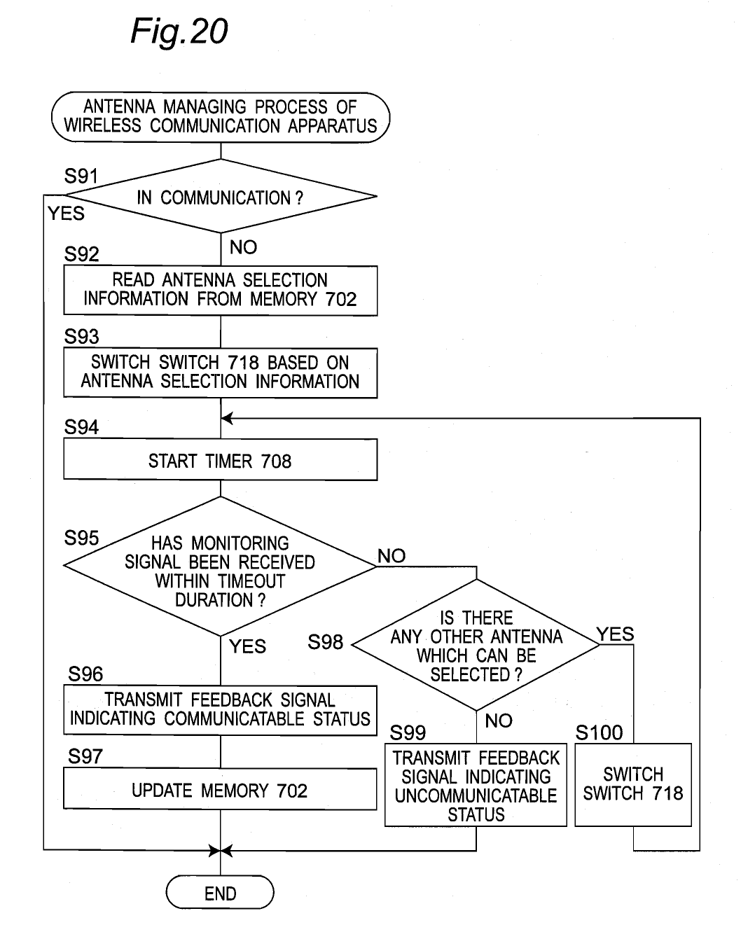

Alternatively, it is also possible to execute processes for determining antennas to be used for transmitting a packet from the wireless repeater apparatus 302a to the wireless communication apparatus 301a, in place of the processes of FIGS. 17 and 18. FIG. 19 is a flow chart showing a modified preferred embodiment of the antenna managing process executed by the antenna control circuit 709 of the wireless repeater apparatus 302a, and FIG. 20 is a flow chart showing the modified preferred embodiment of the antenna managing process executed by the antenna control circuit 701 of the wireless communication apparatus 301a. The processes of FIGS. 19 and 20 are executed when there is no communication for packet relaying, and characterized in that the wireless repeater apparatus 302a determines one transmitting antenna to be used among the transmitting antennas 513, 516 and 519, and the wireless communication apparatus 301a determines one receiving antenna to be used among the receiving antennas 501, 504 and 507.

In step S81 of FIG. 19, the antenna control circuit 709 of the wireless repeater apparatus 302a determines whether or not the wireless repeater apparatus 302a is in communication. If YES, the process flow immediately ends, and if NO, the process flow proceeds to step S82. In step S82, the antenna control circuit 709 reads from the memory 710 the past or initial value of the antenna selection information, and in step S83, turns the switch 719 to select any one of the transmitting antennas 513, 516, 519 based on the antenna selection information. Next, in step S84, the antenna control circuit 709 transmits a monitoring signal from the transmitting antenna selected in step S83, for examining whether or not the transmitting antenna in question can be used for communication, and at the same time, starts counting in the timer circuit 712, and the process flow proceeds to step S85. In step S85, the antenna control circuit 709 determines whether or not the feedback signal has been received through the antenna 521 and the receiver circuit 714b within the timeout duration. If the feedback signal indicating the “communicatable status” has been received, the process flow proceeds to step S86; if the feedback signal indicating the “uncommunicatable status” has been received or if no feedback signal has been received, the process flow proceeds to step S87. In step S86, the antenna control circuit 709 updates the antenna selection information in the memory 710 based on the state of the switch 719 when the monitoring signal is transmitted in step S84, and ends the process. In step S87, the antenna control circuit 709 determines whether or not there is any other antenna which can be selected, and if YES, change the switch 719 in step S88 to return to step S84; if NO, ends the process.

In step S91 of FIG. 20, the antenna control circuit 701 of the wireless communication apparatus 301a determines whether or not the wireless communication apparatus 301a is in communication. If YES, the process flow immediately ends; if NO, the process flow proceeds to step S92. In step S92, the antenna control circuit 701 reads the memory 702 the past or initial value of the antenna selection information, and in step S93, turns the switch 718 to select any one of the receiving antennas 501, 504, 507 based on the antenna selection information, and at the same time with the switching, starts counting in the timer circuit 708 in step S94. Next, in step S95, the antenna control circuit 701 determines whether or not the monitoring signal has been received within the timeout duration. If YES, the process flow proceeds to step S96; if NO, proceeds to step S98. In step S96, the antenna control circuit 701 transmits the feedback signal indicating the “communicatable status” through the transmitter circuit 717a and the antenna 510, and in step S97, updates the antenna selection information in the memory 702 based on the state of the switch 718 when the monitoring signal has been received, and ends the process. In step S98, the antenna control circuit 701 determines whether or not there is any other antenna which can be selected. If YES, the process flow proceeds to step S100; if NO, proceeds to step S99. In step S100, the antenna control circuit 701 change the switch 718, and the process flow returns to step S94. In step S99, the antenna control circuit 701 transmits the feedback signal indicating the “uncommunicatable status” to the wireless repeater apparatus 302a through the transmitter circuit 717a and the antenna 510, and ends the process.

When the transmitting antenna of the wireless repeater apparatus 302a and the receiving antenna of the wireless communication apparatus 301a are selected by the above processes, the antenna control circuit 709 of the wireless repeater apparatus 302a controls the switch 711 to select the receiving antenna paired with the transmitting antenna, and the antenna control circuit 701 of the wireless communication apparatus 301a controls the switch 703 to select the transmitting antenna paired with the receiving antenna.

According to the processes of FIGS. 19 and 20, when there is no communication for packet relaying, the wireless repeater apparatus 302a can determine one transmitting antenna available for communication among the transmitting antennas 513, 516 and 519, and the wireless communication apparatus 301a can determine one receiving antenna available for communication among the receiving antennas 501, 504 and 507.

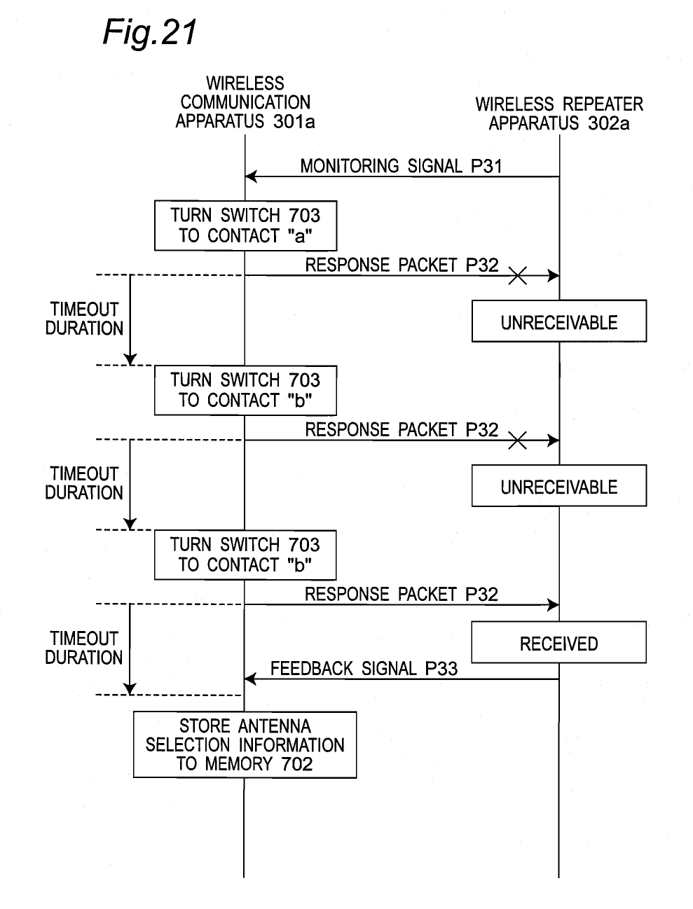

FIG. 21 is a sequence chart showing the monitoring action executed in the wireless communication system of FIG. 11. The monitoring action shows a modified preferred embodiment of the processing for determining the antenna to be used for communication in the wireless communication apparatus 301a, and is characterized in that the wireless repeater apparatus 302a firstly transmits an omni-directional monitoring signal, the wireless communication apparatus 301a having received the monitoring signal transmits response signals by successively changing its transmitting antennas 502, 505 and 508, and thus, the antenna is determined which is located in the direction of the wireless repeater apparatus 302a.

Referring to FIG. 21, the antenna control circuit 709 of the wireless repeater apparatus 302a firstly transmits an omni-directional monitoring signal P31 through the transmitter circuit 714a and the antenna 521. When the monitoring signal P31 is received through the antenna 510 and the receiver circuit 717b of the wireless communication apparatus 301a, the antenna control circuit 701 of the wireless communication apparatus 301a turns the switch 703 to select any one of the transmitting antennas 502, 505 and 508, transmits a response packet P32 from the selected antenna 502, and at the same time, starts counting in timer circuit 708. In the example of FIG. 21, the switch 703 is turned to select the transmitting antenna 502 (i.e., connected to the contact “a”). When the response packet P32 transmitted from the antenna 502 is not received by the wireless repeater apparatus 302a and the feedback signal is not returned to the wireless communication apparatus 301a and then the timeout duration elapses, the antenna control circuit 701 of the wireless communication apparatus 301a turns the switch 703 to select another transmitting antenna 505 (i.e., connect to the contact “b”), and transmits the response packet P32 from the reselected antenna 505, and at the same time, starts counting in the timer circuit 708. When the response packet P32 transmitted from the antenna 505 is not received by the wireless repeater apparatus 302a and the feedback signal is not returned to the wireless communication apparatus 301a and then the timeout duration elapses, the antenna control circuit 701 of the wireless communication apparatus 301a turns the switch 703 to select another transmitting antenna 508 (i.e., connect to the contact “c”), and transmits the response packet P32 from the reselected antenna 508, and at the same time, starts counting in the timer circuit 708. When the response packet P32 transmitted from the antenna 508 is received by the wireless repeater apparatus 302a and the feedback signal P33 is returned to the wireless communication apparatus 301a within the timeout duration, the antenna control circuit 701 of the wireless communication apparatus 301a stores to the memory 702 the state of the switch 703 at the time of transmitting the response packet P32, as antenna selection information available for communication.

After executing the antenna managing process described with reference to FIGS. 17 to 20, or after executing the monitoring action described with reference to FIG. 21, the data packets can be relayed as in the first preferred embodiment.

### Modified Preferred Embodiment of Second Preferred Embodiment

The transmitted contents of the feedback signal transmitted from the feedback transmitter circuit 714a of the wireless repeater apparatus 302a to the feedback receiver circuit 717b of the wireless communication apparatus 301a and indicating the “communicatable status” can generally contain conditions under which the packet, the monitoring signal or the like is received in the wireless repeater apparatus 302a. Particularly, there are the case of the reception result of the wireless data signal (i.e., data indicating the communicatable status or the uncommunicatable status), the case of the reception level of the wireless data signal, the case of switching control content of the switch 703 of the wireless communication apparatus 301a, the case of the data packet received in the receiver circuit 713, 715 or 716 and so on. Likewise, the transmission contents of the feedback signal transmitted from the feedback transmitter circuit 717a of the wireless communication apparatus 301a to the feedback receiver circuit 714b of the wireless repeater apparatus 302a and indicating the “communicatable status” can contain conditions under which the packet, the monitoring signal or the like is received in the wireless communication apparatus 301a.

Although in the present preferred embodiment the address of the wireless repeater apparatus 302a is used as the destination address of the data packet transmitted to the wireless repeater apparatus 302a to select the transmitting antenna of the wireless communication apparatus 301a, it is also possible to use a broadcast address so that all the wireless communication apparatuses including the wireless repeater apparatus 302a receive the address, or to use the address or identifier of a wireless communication apparatus other than the wireless repeater apparatus 302a, such as another wireless communication apparatus that communicates with the wireless repeater apparatus 302a. In this case, the wireless repeater apparatus 302a determines the source and destination of the data packet, and if the data packet can be determined as a data packet transmitted from the wireless communication apparatus 301a, the wireless repeater apparatus 302a transmits a feedback signal indicating the communicatable status from the feedback transmitter circuit 714a to the wireless communication apparatus 301a

Moreover, although the example has been described in which the memory 702 of the wireless communication apparatus 301a is connected to the antenna control circuit 701, the memory may be connected to a component other than the antenna control circuit 701. Moreover, although the counting in the timer circuit 708 of the wireless communication apparatus 301a is started by the antenna control circuit 701, the counting may be started by a component other than the antenna control circuit 701. Moreover, although the example has been described in which the memory 710 of the wireless repeater apparatus 302a is connected to the antenna control circuit 709, the memory may be connected to a component other than the antenna control circuit 709. Moreover, although the counting in the timer circuit 712 of the wireless repeater apparatus 302a is started by the antenna control circuit 709, the counting may be started by a component other than the antenna control circuit 709.

In the wireless communication apparatus 301a, the antenna control circuit 701 and the wireless communication apparatus control circuit 704 may be configured as one circuit. Likewise, in the radio repeater apparatus 302a, the antenna control circuit 709 and the wireless repeater apparatus control circuit 404 may be configured as one circuit.

Moreover, although the transmitter circuits 705, 706, 707 are provided to be connected to the switch 703 of the wireless communication apparatus 301a for every one of the transmitting antennas 502, 505 and 508, alternatively, it is also possible to provide one or more transmitter circuits between the switch 703 and the wireless communication apparatus control circuit 704. Moreover, although the receiver circuits 720, 721, 722 are provided to be connected to the switch 718 of the wireless communication apparatus 301a for every one of the receiving antennas 501, 504 and 507, alternatively, it is also possible to provide one or more receiver circuits between the switch 718 and the wireless communication apparatus control circuit 704. Moreover, although the receiver circuits 713, 715, 716 are provided to be connected to the switch 711 of the wireless repeater apparatus 302a for every one of the receiving antennas 512, 515 and 518, alternatively, it is also possible to provide one or more receiver circuits between the switch 711 and the memory 402. Moreover, although the transmitter circuits 723, 724, 725 are provided to be connected to the switch 719 of the wireless communication apparatus 301a for every one of the transmitting antennas 513, 516 and 519, alternatively, it is also possible to provide one or more transmitter circuits between the switch 719 and the switching circuit 406.

Moreover, although the wireless communication apparatus 301a has the feedback transmitter circuit 717a, the feedback receiver circuit 717b and the circulator 510a while the wireless repeater apparatus 302a has the feedback transmitter circuit 714a, the feedback receiver circuit 714b and the circulator 521a, it is also possible to restrict the direction in which the feedback signal is transmitted, to only one direction, and provide that the wireless communication apparatus 301a with only the feedback transmitter circuit 717a and provide the wireless repeater apparatus 302a with only the feedback receiver circuit 714b, or alternatively, provide the wireless communication apparatus 301a with only the feedback receiver circuit 717b and provide the wireless repeater apparatus 302a with only the feedback transmitter circuit 714a. Alternatively, it is also possible to provide a configuration in which the data packet is transmitted from other transmitter circuit of the wireless communication apparatus 301a and received by other receiver circuit of the wireless repeater apparatus 302a, and the feedback signal indicating the result of the communicatable status or the uncommunicatable status is transmitted from other transmitter circuit of the wireless repeater apparatus 302a and received by other receiver circuit of the wireless communication apparatus 301a.

Moreover, the wireless communication apparatus 301a has been constituted of the plurality of transmitter circuits and transmitting antennas switched by the switch 703, the plurality of receiver circuits and receiving antennas switched by the switch 718, the feedback transmitter circuit 717a and the feedback receiver circuit 717b, and the antenna 510. Alternatively, it is also possible to implement the functions of the receiver circuits and the receiving antennas switched by the switch 718, by means of the feedback receiver circuit 717 and the receiving antenna 510, and thereby to constitute the wireless communication apparatus 301a of a plurality of transmitter circuits and transmitting antennas switched by the switch 703, the feedback receiver circuit 717 and the receiving antenna 510. Moreover, the wireless repeater apparatus 302a has been constituted of the plurality of transmitter circuits and transmitting antennas switched by the switch 719, the plurality of receiver circuits and receiving antennas switched by the switch 711, the feedback transmitter circuit 714a and the feedback receiver circuit 714b, and the antenna 521. Alternatively, it is also possible to implement the functions of the transmitter circuits and the transmitting antennas switched by the switch 719, by means of the feedback transmitter circuit 714 and the transmitting antenna 521, and thereby to constitute the wireless repeater apparatus 302a of the feedback transmitter circuit 714, the transmitting antenna 521 and a plurality of receiver circuits and receiving antennas switched by the switch 711. Moreover, although the wireless repeater apparatus 302a has been constituted of the plurality of transmitter circuits and transmitting antennas switched by the switch 719, the plurality of receiver circuits and receiving antennas switched by the switch 711, the feedback transmitter circuit 714a and the feedback receiver circuit 714b, the transmitting antenna 521, the plurality of transmitter circuits and transmitting antennas and the plurality of receiver circuits and receiving antennas. Alternatively, the wireless repeater apparatus 302a may be constituted of a plurality of transmitter circuits and transmitting antennas switched by the switch 719, a plurality of receiver circuits and receiving antennas switched by the switch 711, the feedback transmitter circuit 714 and the transmitting antenna 521.

The timer circuits 708, 712 may be reset and stopped when the counting is stopped. In this case, the counting can be stopped when the feedback signal is received for the packet transmitted at the time of starting the count, or when the packet has not been received from turning the switches 711, 718 to the certain receiving antennas until the timeout duration elapses, or when the timeout duration has elapsed without receiving the feedback signal for the transmitted packet.

Although the patterns of the antennas 510, 521 have been omni-directional, alternatively, an antenna having a directional pattern capable of transmitting and receiving in a wide azimuth angle may be employed.

Although only the antenna port of the antennas 305, 306 of FIG. 3 has been replaced by the extended antenna port that has the plurality of antenna pairs: 512, 513; 515, 516; and 518, 519 in the wireless repeater apparatus 302a of the present preferred embodiment, it is also possible to further similarly replace the other antenna ports each with an extended antenna port that has a plurality of antenna pairs.

Moreover, although radio waves have been utilized for the communications between the wireless communication apparatus 301a and the wireless repeater apparatus 302a in the first and second preferred embodiments of the present invention, it is also possible to use another communication method such as infrared communication or optical communication. In this case, a plurality of light emitting portions and light receiving portions are connected to the antenna control circuits 701 and 709, although the plurality of transmitting antennas or receiving antennas are connected in the switching manner by the antenna control circuits 701 and 709 in the present preferred embodiment.

### INDUSTRIAL APPLICABILITY

As described in detail above, the wireless communication system of the present invention can obviate the need for the process of newly setting the direction of communication when the wireless communication apparatus that needs communication direction setting changes the remote party of communication, and is therefore useful as a wireless communication system or the like that needs communication direction setting.

1-32. (canceled)

33. A wireless repeater apparatus for communicating with at least two wireless communication apparatuses, the wireless repeater apparatus comprising:
a plurality of antennas;
a switching circuit for transferring a communication signal received through any one of the plurality of antennas to any one of the plurality of antennas for transmitting the same communication signal therefrom;
a correspondence table memory for storing a correspondence table that includes relations in which an identifier of each antenna is correspondingly associated with an identifier of one wireless communication apparatus communicatable by using the antenna specified by the identifier of the antenna, and
a wireless repeater apparatus control circuit for controlling transfer of the communication signal by the switching circuit, based on the correspondence table,
wherein when the communication signal is received through any one of the plurality of antennas, the wireless repeater apparatus control circuit obtains from the correspondence table the identifier of the antenna corresponding to an identifier of a destination wireless communication apparatus of the received communication signal, and controls the switching circuit to transfer the received communication signal to the antenna specified by the obtained identifier of the antenna for transmitting the same communication signal therefrom.

34. The wireless repeater apparatus as claimed in claim 33, wherein when relaying a communication between a first wireless communication apparatus and a second wireless communication apparatus, the wireless repeater apparatus
transmits a communication response signal to the first wireless communication apparatus on behalf of the second wireless communication apparatus upon receiving a communication signal transmitted from the first wireless communication apparatus and addressed to the second wireless communication apparatus, and
transmits a communication response signal to the second wireless communication apparatus on behalf of the first wireless communication apparatus upon receiving a communication signal transmitted from the second wireless communication apparatus and addressed to the first wireless communication apparatus.

35. The wireless repeater apparatus as claimed in claim 33,
wherein when a communication signal from a certain wireless communication apparatus is received through any one of the plurality of antennas, the wireless repeater apparatus control circuit further updates the correspondence table so as to add a relation in which the identifier of the antenna that has received the communication signal is correspondingly associated with an identifier of a source wireless communication apparatus of the communication signal, and
wherein the wireless repeater apparatus control circuit further:
receives a communication signal addressed to a certain wireless communication apparatus through any one of the plurality of antennas,
transfers the received communication signal to an antenna specified by the identifier of the antenna corresponding to the identifier of the destination wireless communication apparatus of the received communication signal in the correspondence table, for transmitting the same communication signal therefrom, and
when a communication response signal for the transmitted communication signal has not been received from the destination wireless communication apparatus within a certain time period, deletes from the correspondence table the identifier of the wireless communication apparatus corresponding to the identifier of the antenna that has transmitted the communication signal.

36. The wireless repeater apparatus as claimed in claim 35, wherein the wireless repeater apparatus control circuit further:
selects an identifier of a certain wireless communication apparatus in the correspondence table,
obtains an identifier of an antenna corresponding to the identifier of the selected wireless communication apparatus from the correspondence table,
generates a monitoring signal,
transmits the generated monitoring signal from the antenna specified by the obtained identifier of the antenna, and
when a monitoring response signal for the transmitted monitoring signal has not been received from the wireless communication apparatus specified by the selected identifier of the wireless communication apparatus within a certain time period, deletes the selected identifier of the wireless communication apparatus from the correspondence table.

37. The wireless repeater apparatus as claimed in claim 33,
wherein the wireless repeater apparatus further comprises communication signal memory for storing the received communication signal, and
wherein when a communication response signal for the transmitted communication signal has not been received from the destination wireless communication apparatus within a certain time period, the wireless repeater apparatus control circuit further controls the switching circuit to transfer the communication signal that has been received and stored in the communication signal memory, to an antenna specified by the identifier of the antenna that does not have any identifier of the corresponding wireless communication apparatus in the correspondence table, for retransmitting the same communication signal therefrom.

38. A wireless communication system including at least two wireless communication apparatuses, and a wireless repeater apparatus communicating with the wireless communication apparatuses,
wherein the wireless repeater apparatus comprises:
a plurality of antennas;
a switching circuit for transferring a communication signal received through any one of the plurality of antennas to any one of the plurality of antennas for transmitting the same communication signal therefrom;
a correspondence table memory for storing a correspondence table that includes relations in which an identifier of each antenna is correspondingly associated with an identifier of one wireless communication apparatus communicatable by using the antenna specified by the identifier of the antenna, and
a wireless repeater apparatus control circuit for controlling transfer of the communication signal by the switching circuit, based on the correspondence table,
wherein when the communication signal is received through any one of the plurality of antennas, the wireless repeater apparatus control circuit obtains from the correspondence table the identifier of the antenna corresponding to an identifier of a destination wireless communication apparatus of the received communication signal, and controls the switching circuit to transfer the received communication signal to the antenna specified by the obtained identifier of the antenna for transmitting the same communication signal therefrom,
wherein the wireless repeater apparatus further comprises:
at least one first antenna set comprised of antennas sharing the same identifier of the antenna, among the plurality of antennas,
a first antenna selecting circuit switchable to select one antenna of each of the first antenna set, and
a feedback transmitting circuit for transmitting, when the first antenna selecting circuit is switched to select one antenna of each of the first antenna set, a feedback signal that contains reception state information of the communication signal transmitted from the wireless communication apparatus and received through the selected antenna, to the source wireless communication apparatus of the communication signal,
wherein the wireless repeater apparatus control circuit further controls the first antenna selecting circuit based on the reception state information of the communication signal, to receive the communication signal transmitted from the source wireless communication apparatus of the communication signal, and
wherein the at least one wireless communication apparatus comprises:
at least one second antenna set comprised of antennas,
a second antenna selecting circuit switchable to select one antenna of each of the second antenna set,
a feedback receiving circuit for receiving the feedback signal transmitted from the wireless repeater apparatus, and
a wireless communication apparatus control circuit for controlling the second antenna selecting circuit, and
wherein when the second antenna selecting circuit is switched to select one antenna of each of the second antenna set, the wireless communication apparatus control circuit further transmits the communication signal to the wireless repeater apparatus through the selected antenna, and controls the second antenna selecting circuit based on the reception state information contained in the received feedback signal, so that the communication signal is received by the wireless repeater apparatus.

39. A wireless communication system including at least two wireless communication apparatuses, and a wireless repeater apparatus communicating with the wireless communication apparatuses,
wherein the wireless repeater apparatus comprises:
a plurality of antennas;
a switching circuit for transferring a communication signal received through any one of the plurality of antennas to any one of the plurality of antennas for transmitting the same communication signal therefrom;
a correspondence table memory for storing a correspondence table that includes relations in which an identifier of each antenna is correspondingly associated with an identifier of one wireless communication apparatus communicatable by using the antenna specified by the identifier of the antenna, and
a wireless repeater apparatus control circuit for controlling transfer of the communication signal by the switching circuit, based on the correspondence table,
wherein when the communication signal is received through any one of the plurality of antennas, the wireless repeater apparatus control circuit obtains from the correspondence table the identifier of the antenna corresponding to an identifier of a destination wireless communication apparatus of the received communication signal, and controls the switching circuit to transfer the received communication signal to the antenna specified by the obtained identifier of the antenna for transmitting the same communication signal therefrom,
wherein the wireless repeater apparatus further comprises:
at least one first antenna set comprised of antennas sharing the same identifier of the antenna, among the plurality of antennas,
a first antenna selecting circuit switchable to select one antenna of each of the first antenna set, and
a feedback receiving circuit for receiving, when the first antenna selecting circuit is switched to select one antenna of each of the first antenna set, a feedback signal that contains reception state information of the communication signal transmitted through the selected antenna and received by the wireless communication apparatus, from the wireless communication apparatus,
wherein when the first antenna selecting circuit is switched to select one antenna of each of the first antenna set, the wireless repeater apparatus control circuit further transmits the communication signal to the wireless communication apparatus through the selected antenna, and controls the first antenna selecting circuit based on the reception state information contained in the received feedback signal, so that the communication signal is received by the wireless communication apparatus,
wherein the at least one wireless communication apparatus comprises:
at least one second antenna set comprised of antennas,
a second antenna selecting circuit switchable to select one antenna of each of the second antenna set, and
a feedback transmitting circuit for transmitting, when the second antenna selecting circuit is switched to select one antenna of each of the second antenna set, a feedback signal that contains reception state information of the communication signal transmitted from the wireless repeater apparatus and received through the selected antenna, to the wireless repeater apparatus, and
wireless communication apparatus control circuit for controlling the second antenna selecting circuit, and
wherein the wireless communication apparatus control circuit further controls the second antenna selecting circuit based on the reception state information of the communication signal, to receive the communication signal transmitted from the wireless repeater apparatus.

40. The wireless repeater apparatus as claimed in claim 33, wherein the wireless repeater apparatus further comprises:
at least one antenna set comprised of antennas sharing the same identifier of the antenna, among the plurality of antennas,
an antenna selecting circuit switchable to select one antenna of each of the antenna set, and
a feedback transmitting circuit for transmitting, when the antenna selecting circuit is switched to select one antenna of each of the antenna set, a feedback signal that contains reception state information of the communication signal transmitted from a wireless communication apparatus and received through the selected antenna, to the source wireless communication apparatus of the communication signal, and
wherein the wireless repeater apparatus control circuit further controls the antenna selecting circuit based on the reception state information of the communication signal, to receive the communication signal transmitted from the source wireless communication apparatus of the communication signal.

41. The wireless repeater apparatus as claimed in claim 33, wherein the wireless repeater apparatus further comprises:
at least one antenna set comprised of antennas sharing the same identifier of the antenna, among the plurality of antennas,
an antenna selecting circuit switchable to select one antenna of each of the antenna set, and
a feedback receiving circuit for receiving, when the antenna selecting circuit is switched to select one antenna of each of the antenna set,
a feedback signal that contains reception state information of the communication signal transmitted through the selected antenna and received by a wireless communication apparatus, from the wireless communication apparatus, and
wherein when the antenna selecting circuit is switched to select one antenna of each of the antenna set, the wireless repeater apparatus control circuit further transmits the communication signal to the wireless communication apparatus through the selected antenna, and controls the antenna selecting circuit based on the reception state information contained in the received feedback signal, so that the communication signal is received by the wireless communication apparatus.

42. A wireless communication apparatus for communicating with a wireless repeater apparatus, the wireless repeater apparatus communicating with at least two wireless communication apparatuses,
wherein the wireless repeater apparatus comprises:
a plurality of antennas;
a switching circuit for transferring a communication signal received through any one of the plurality of antennas to any one of the plurality of antennas for transmitting the same communication signal therefrom;
a correspondence table memory for storing a correspondence table that includes relations in which an identifier of each antenna is correspondingly associated with an identifier of one wireless communication apparatus communicatable by using the antenna specified by the identifier of the antenna, and
a wireless repeater apparatus control circuit for controlling transfer of the communication signal by the switching circuit, based on the correspondence table,
wherein when the communication signal is received through any one of the plurality of antennas, the wireless repeater apparatus control circuit obtains from the correspondence table the identifier of the antenna corresponding to an identifier of a destination wireless communication apparatus of the received communication signal, and controls the switching circuit to transfer the received communication signal to the antenna specified by the obtained identifier of the antenna for transmitting the same communication signal therefrom,
wherein the wireless repeater apparatus further comprises:
at least one first antenna set comprised of antennas sharing the same identifier of the antenna, among the plurality of antennas,
a first antenna selecting circuit switchable to select one antenna of each of the first antenna set, and
a feedback transmitting circuit for transmitting, when the first antenna selecting circuit is switched to select one antenna of each of the first antenna set, a feedback signal that contains reception state information of the communication signal transmitted from the wireless communication apparatus and received through the selected antenna, to the source wireless communication apparatus of the communication signal,
wherein the wireless repeater apparatus control circuit further controls the first antenna selecting circuit based on the reception state information of the communication signal, to receive the communication signal transmitted from the source wireless communication apparatus of the communication signal, and
wherein the wireless communication apparatus comprising:
at least one second antenna set comprised of antennas,
a second antenna selecting circuit switchable to select one antenna of each of the second antenna set,
a feedback receiving circuit for receiving, when the antenna selecting circuit is switched to select one antenna of each of the second antenna set, the feedback signal that contains reception state information of the communication signal transmitted through the selected antenna and received by the wireless repeater apparatus, from the wireless repeater apparatus, and
a wireless communication apparatus control circuit for controlling the second antenna selecting circuit,
wherein when the second antenna selecting circuit is switched to select one antenna of each of the second antenna set, the wireless communication apparatus control circuit further transmits the communication signal to the wireless repeater apparatus through the selected antenna, and controls the second antenna selecting circuit based on the reception state information contained in the received feedback signal, so that the communication signal is received by the wireless repeater apparatus.

43. A wireless communication apparatus for communicating with a wireless repeater apparatus, the wireless repeater apparatus communicating with at least two wireless communication apparatuses,
wherein the wireless repeater apparatus comprises:
a plurality of antennas;
a switching circuit for transferring a communication signal received through any one of the plurality of antennas to any one of the plurality of antennas for transmitting the same communication signal therefrom;
a correspondence table memory for storing a correspondence table that includes relations in which an identifier of each antenna is correspondingly associated with an identifier of one wireless communication apparatus communicatable by using the antenna specified by the identifier of the antenna, and
a wireless repeater apparatus control circuit for controlling transfer of the communication signal by the switching circuit, based on the correspondence table,
wherein when the communication signal is received through any one of the plurality of antennas, the wireless repeater apparatus control circuit obtains from the correspondence table the identifier of the antenna corresponding to an identifier of a destination wireless communication apparatus of the received communication signal, and controls the switching circuit to transfer the received communication signal to the antenna specified by the obtained identifier of the antenna for transmitting the same communication signal therefrom,
wherein the wireless repeater apparatus further comprises:
at least one first antenna set comprised of antennas sharing the same identifier of the antenna, among the plurality of antennas,
a first antenna selecting circuit switchable to select one antenna of each of the first antenna set, and
a feedback receiving circuit for receiving, when the first antenna selecting circuit is switched to select one antenna of each of the first antenna set, a feedback signal that contains reception state information of the communication signal transmitted through the selected antenna and received by the wireless communication apparatus, from the wireless communication apparatus,
wherein when the first antenna selecting circuit is switched to select one antenna of each of the first antenna set, the wireless repeater apparatus control circuit further transmits the communication signal to the wireless communication apparatus through the selected antenna, and controls the first antenna selecting circuit based on the reception state information contained in the received feedback signal, so that the communication signal is received by the wireless communication apparatus,
wherein the wireless communication apparatus comprising:
at least one second antenna set comprised of antennas,
a second antenna selecting circuit switchable to select one antenna of each of the second antenna set,
a feedback transmitting circuit for transmitting, when the second antenna selecting circuit is switched to select one antenna of each of the second antenna set, the feedback signal that contains reception state information of the communication signal transmitted from the wireless repeater apparatus and received through the selected antenna, to the wireless repeater apparatus, and
a wireless communication apparatus control circuit for controlling the second antenna selecting circuit,
wherein the wireless communication apparatus control circuit further controls the second antenna selecting circuit based on the reception state information of the communication signal, to receive the communication signal transmitted from the wireless repeater apparatus.

44. The wireless communication system as claimed in claim 38,
wherein the wireless repeater apparatus further comprises a first antenna selection information memory for storing antenna selection information indicating the antenna that has been selected by the first antenna selecting circuit when the communication signal is received from the wireless communication apparatus,
wherein when newly receiving a communication signal from the wireless communication apparatus, the wireless repeater apparatus control circuit reads the antenna selection information from the first antenna selection information memory, and switches the first antenna selecting circuit based on the read antenna selection information, so as to select one antenna of each of the first antenna set,
wherein the wireless communication apparatus further comprises a second antenna selection information memory for storing antenna selection information indicating the antenna that has been selected by the second antenna selecting circuit when the communication signal is received by the wireless repeater apparatus, and
wherein when newly transmitting a communication signal to the wireless repeater apparatus, the wireless communication apparatus control circuit reads the antenna selection information from the second antenna selection information memory, and switches the second antenna selecting circuit based on the read antenna selection information, so as to select one antenna of each of the second antenna set.

45. The wireless communication system as claimed in claim 39,
wherein the wireless repeater apparatus further comprises a first antenna selection information memory for storing antenna selection information indicating the antenna that has been selected by the first antenna selecting circuit when the communication signal is received by the wireless communication apparatus,
wherein when newly transmitting a communication signal to the wireless communication apparatus, the wireless repeater apparatus control circuit reads the antenna selection information from the first antenna selection information memory, and switches the first antenna selecting circuit based on the read antenna selection information, so as to select one antenna of each of the first antenna set,
wherein the wireless communication apparatus further comprises a second antenna selection information memory for storing antenna selection information indicating the antenna that has been selected by the second antenna selecting circuit when the communication signal is received from the wireless repeater apparatus, and
wherein when newly receiving a communication signal from the wireless repeater apparatus, the wireless communication apparatus control circuit reads the antenna selection information from the second antenna selection information memory, and switches the second antenna selecting circuit based on the read antenna selection information, so as to select one antenna of each of the second antenna set.

46. The wireless repeater apparatus as claimed in claim 40,
wherein the wireless repeater apparatus further comprises an antenna selection information memory for storing antenna selection information indicating the antenna that has been selected by the antenna selecting circuit when the communication signal is received from the wireless communication apparatus,
wherein when newly receiving a communication signal from the wireless communication apparatus, the wireless repeater apparatus control circuit reads the antenna selection information from the antenna selection information memory, and switches the antenna selecting circuit based on the read antenna selection information, so as to select one antenna of each of the antenna set.

47. The wireless repeater apparatus as claimed in claim 41,
wherein the wireless repeater apparatus further comprises an antenna selection information memory for storing antenna selection information indicating the antenna that has been selected by the second antenna selecting circuit when the communication signal is received by the wireless communication apparatus,
wherein when newly transmitting a communication signal to the wireless communication apparatus, the wireless repeater apparatus control circuit reads the antenna selection information from the antenna selection information memory, and switches the second antenna selecting circuit based on the read antenna selection information, so as to select one antenna of each of the second antenna set.

48. The wireless communication apparatus as claimed in claim 42,
wherein the wireless communication apparatus further comprises an antenna selection information memory for storing antenna selection information indicating the antenna that has been selected by the second antenna selecting circuit when the communication signal is received by the wireless repeater apparatus, and
wherein when newly transmitting a communication signal to the wireless repeater apparatus, the wireless communication apparatus control circuit reads the antenna selection information from the antenna selection information memory, and switches the second antenna selecting circuit based on the read antenna selection information, so as to select one antenna of each of the second antenna set.

49. The wireless communication apparatus as claimed in claim 43,
wherein the wireless communication apparatus further comprises an antenna selection information memory for storing antenna selection information indicating the antenna that has been selected by the antenna selecting circuit when the communication signal is received from the wireless repeater apparatus, and
wherein when newly receiving a communication signal from the wireless repeater apparatus, the wireless communication apparatus control circuit reads the antenna selection information from the antenna selection information memory, and switches the antenna selecting circuit based on the read antenna selection information, so as to select one antenna of each of the antenna set.

50. The wireless communication system as claimed in claim 38,
wherein each of the first antenna set comprises a plurality of first antenna pairs each including one transmitting antenna and one receiving antenna corresponding to each other,
wherein the first antenna selecting circuit selects, upon selecting one receiving antenna of each of the first antenna set, one transmitting antenna corresponding to the selected receiving antenna,
wherein each of the second antenna set comprises a plurality of second antenna pairs each including one transmitting antenna and one receiving antenna corresponding to each other, and
wherein the second antenna selecting circuit selects, upon selecting one transmitting antenna of each of the first antenna set, one receiving antenna corresponding to the selected transmitting antenna.

51. The wireless communication system as claimed in claim 39,
wherein each of the first antenna set comprises a plurality of first antenna pairs each including one transmitting antenna and one receiving antenna corresponding to each other,
wherein the first antenna selecting circuit selects, upon selecting one transmitting antenna of each of the first antenna set, one receiving antenna corresponding to the selected transmitting antenna,
wherein each of the second antenna set comprises a plurality of second antenna pairs each including one transmitting antenna and one receiving antenna corresponding to each other, and
wherein the second antenna selecting circuit selects, upon selecting one receiving antenna of each of the second antenna set, one transmitting antenna corresponding to the selected receiving antenna.

52. The wireless repeater apparatus as claimed in claim 40,
wherein each of the antenna set comprises a plurality of antenna pairs each including one transmitting antenna and one receiving antenna corresponding to each other,
wherein the antenna selecting circuit selects, upon selecting one receiving antenna of each of the antenna set, one transmitting antenna corresponding to the selected receiving antenna.

53. The wireless repeater apparatus as claimed in claim 41,
wherein each of the antenna set comprises a plurality of antenna pairs each including one transmitting antenna and one receiving antenna corresponding to each other,
wherein the antenna selecting circuit selects, upon selecting one transmitting antenna of each of the antenna set, one receiving antenna corresponding to the selected transmitting antenna.

54. The wireless communication apparatus as claimed in claim 42,
wherein each of the second antenna set comprises a plurality of antenna pairs each including one transmitting antenna and one receiving antenna corresponding to each other, and
wherein the second antenna selecting circuit selects, upon selecting one transmitting antenna of each of the second antenna set, one receiving antenna corresponding to the selected transmitting antenna.

55. The wireless communication apparatus as claimed in claim 43,
wherein each of the second antenna set comprises a plurality of antenna pairs each including one transmitting antenna and one receiving antenna corresponding to each other, and
wherein the second antenna selecting circuit selects, upon selecting one receiving antenna of each of the second antenna set, one transmitting antenna corresponding to the selected receiving antenna.
